(19) United States
(12) Patent Application Publication
(10) Pub. No.: US 2026/0292900 A1
(43) Pub. Date: Sep. 24, 2026

(54) POLICY CONTROL METHOD, CHARGING METHOD, APPARATUS, AND STORAGE MEDIUM

(71) Applicant: BEIJING XIAOMI MOBILE SOFTWARE CO., LTD., Beijing (CN)

(72) Inventor: Chunhui ZHU, Beijing (CN)

(21) Appl. No.: 19/476,434

(22) PCT Filed: Apr. 19, 2023
(86) PCT No.: PCT/CN2023/089338

§ 371 Date: Oct. 17, 2025

(51) Int. Cl. H04W 76/10; H04L 12/14; H04W 60/00

(52) U.S. Cl. CPC H04W 76/10; H04L 12/14; H04W 60/00

(57) ABSTRACT

A policy control method, is performed by a terminal, where the terminal is an ambient power-enabled Internet of Things device, and the policy control method includes the following steps: sending a first message to an access network device, where the first message is configured to perform policy control on the terminal.

### CROSS REFERENCE TO RELATED APPLICATION

The present application is a U.S. National Stage of International Application No. PCT/CN2023/089338, filed on Apr. 19, 2023, the entire contents of which are incorporated herein by reference.

### BACKGROUND OF THE INVENTION

In a wireless communication system, mobile data services of a terminal keep increasing. In order to satisfy requirements from a user for communication quality and charge for different services, a policy control function and charging control are introduced into the 3rd Generation Partnership Project (3GPP).

### SUMMARY OF THE INVENTION

According to a first aspect of the embodiments of the present disclosure, a policy control method is provided. The method is performed by a terminal and includes:
sending a first message to an access network device. The first message is configured to perform policy control on the terminal.

According to a second aspect of the embodiments of the present disclosure, a policy control method is provided. The method is performed by an access network device and includes:
receiving a first message sent by a terminal, where the first message is configured to perform policy control on the terminal, and the terminal is an ambient power-enabled Internet of Things device; and
sending a registration request to an Access and Mobility Management Function (AMF), where the registration request includes at least one of the first message or a first Radio Access Technology (RAT) type, and the first RAT type is an RAT type used by the terminal to access the access network device.

According to a third aspect of the embodiments of the present disclosure, a method is provided. The method is performed by a communication system, the communication system includes an AMF, and the method includes:
receiving, by the AMF, a registration request sent by an access network device, where the registration request includes at least one of a first message or a first RAT type, the first RAT type is an RAT type used by a terminal to access the access network device, the first message is configured to perform policy control on the terminal, and the terminal is an ambient power-enabled Internet of Things device;
determining, by the AMF, an RAT type of the terminal; and
sending, by the AMF, a second message to the access network device, where the second message indicates a network resource used by the terminal.

According to a fourth aspect of the embodiments of the present disclosure, a terminal is provided. The terminal includes a processor and a memory, the memory is configured to store a computer program, and the processor is configured to execute the computer program to perform the method of the first aspect.

According to a fifth aspect of the embodiments of the present disclosure, an access network device is provided. The access network device includes a processor and a memory, the memory is configured to store a computer program, and the processor is configured to execute the computer program to perform the method of the second aspect.

According to a sixth aspect of the embodiments of the present disclosure, a communication system is provided. The communication system includes a processor and a memory, the memory is configured to store a computer program, and the processor is configured to execute the computer program to perform the method of the third aspect.

### BRIEF DESCRIPTION OF DRAWINGS

The drawings here are incorporated into the specification, constitute a part of the specification, illustrate embodiments conforming to the present disclosure, and are used to explain principles of the present disclosure along with the specification.

FIG. 1 is a schematic diagram of a communication system according to an example.

FIG. 2 is a schematic diagram of another communication system according to an example.

FIG. 3 is a schematic diagram of an ambient power-enabled Internet of Things according to an example.

FIG. 4 is a flowchart of a policy control method according to an example.

FIG. 5 is a flowchart of a policy control method according to an example.

FIG. 6 is a flowchart of a policy control method according to an example.

FIG. 7 is a flowchart of a policy control method according to an example.

FIG. 8 is a flowchart of a policy control method according to an example.

FIG. 9 is a flowchart of a policy control method according to an example.

FIG. 10 is a flowchart of a policy control method according to an example.

FIG. 11 is a flowchart of a policy control method according to an example.

FIG. 12 is a flowchart of a policy control method according to an example.

FIG. 13 is a flowchart of a policy control method according to an example.

FIG. 14 is a flowchart of a policy control method according to an example.

FIG. 15 is a flowchart of a policy control method according to an example.

FIG. 16 is a flowchart of a policy control method according to an example.

FIG. 17 is a flowchart of a policy control method according to an example.

FIG. 18 is a flowchart of a charging method according to an example.

FIG. 19 is a flowchart of a charging method according to an example.

FIG. 20 is a flowchart of a charging method according to an example.

FIG. 21 is a flowchart of a policy control method and a charging method according to an example.

FIG. 22 is a block diagram of a terminal according to an example.

FIG. 23 is a block diagram of an access network device according to an example.

FIG. 24 is a block diagram of an AMF according to an example.

FIG. 25 is a block diagram of a Session Management Function (SMF) according to an example.

FIG. 26 is a block diagram of a Charging Function (CHF) according to an example.

FIG. 27 is a block diagram of a communication device according to an example.

### DETAILED DESCRIPTION OF THE INVENTION

Examples are described in detail here, and their instances are shown in the accompanying drawings. In a case where the following description involves the accompanying drawings, unless otherwise indicated, the same numerals in different accompanying drawings indicate the same or similar elements. Implementations described in the following examples do not represent all implementations consistent with the present disclosure. On the contrary, these implementations are merely examples of devices and methods consistent with some aspects of the present disclosure as detailed in the appended claims.

The terms “first,” “second,” etc. used in the description of the embodiments of the present disclosure are used to distinguish similar objects, but are not necessarily understood as a specific sequence or sequential order. In addition, unless otherwise specified, in the description with reference to the accompanying drawings, the same reference numerals in different accompanying drawings indicate the same element.

In the description of the embodiments of the present disclosure, unless otherwise specified, “a plurality of” indicates two or more, and other quantifiers have similar indications. Expressions “at least one,” “one or more,” or other similar expressions indicate any combination of those ones, and include any combination of a single one or plural ones. For example, “at least one” may indicate any number. For another example, “one or more of a, b, and c” may indicate a, b, c, a-b, a-c, b-c, or a-b-c, and a, b, and c may be single or plural. The term “and/or” is an association relationship that describes associated objects, and indicates that three types of relationships may exist. For example, “A and/or B” may indicate that A exists alone, A and B exist simultaneously, and B exists alone, and A and B may be single or plural. The character “/” indicates that the associated objects before and after the character are in an “or” relationship. Singular forms such as “one,” “a,” “an,” “this,” “the,” “the above,” and “the foregoing” are also intended to include plural forms, unless otherwise clearly indicated in the context.

In the description of the embodiments of the present disclosure, expressions such as “in a case A, in another case B,” and “in response to a case A, in response to another case B” may include the following technical solutions according to the situation: A is performed independently of B, i.e., in some embodiments A; B is performed independently of A, i.e., in some embodiments B; A and B are selectively performed, i.e., in some embodiments, A or B is selected to be performed; or both A and B are performed, i.e., in some embodiments A and B. More branches, such as A, B, and C, also have similar indications described above.

In the description of the embodiments of the present disclosure, “including A,” “containing A,” “configured to indicate A,” and “carrying A” may be interpreted as directly carrying A or indirectly indicating A.

In the description of the embodiments of the present disclosure, terms such as “in response to . . . ,” “in response to determining . . . ,” “in a case where . . . ,” “at the time of . . . ,” “when . . . ,” and “if . . . ” are interchangeable.

In some embodiments, terms such as “greater than,” “greater than or equal to,” “above,” “higher than,” and “not less than” are interchangeable, and terms such as “less than,” “less than or equal to,” “below,” “lower than,” and “not greater than” are interchangeable.

In some embodiments, “predetermined” and “preset” may be interpreted as being predefined in a protocol, or may be interpreted as actions being preset for a device, etc.

In some embodiments, the device, etc. may be interpreted as a physical device or a virtual device, and its name is not limited to the names described in the embodiments. Terms such as “apparatus,” “equipment,” “device,” “network element,” “node,” “function,” “unit,” “entity,” “system,” “chip,” “chip system,” and “subject” are interchangeable.

In some embodiments, the name of information, etc. is not limited to the names described in the embodiments. Terms such as “information,” “message,” “signaling,” “report,” “configuration,” “indication,” “parameter,” and “data” are interchangeable.

In some embodiments, terms such as “instructions” and “program” are interchangeable.

In some embodiments, terms such as “obtain,” “acquire,” “get,” “receive,” and “transmit (send and/or receive)” are interchangeable, and may be interpreted as a plurality of meanings, such as receiving from another subject, obtaining from a protocol, getting by self processing, and autonomous implementation.

In some embodiments, terms such as “send,” “report,” “issue,” and “transmit (send and/or receive)” are interchangeable.

In some embodiments, obtaining of data, information, etc. may comply with the laws and regulations of the country.

In some embodiments, data, information, etc. may be obtained after consent of a user is obtained.

In addition, each element, each row, or each column in a table involved in the embodiments of the present disclosure may be implemented as an independent embodiment, and a combination of any element, any row, or any column may also be implemented as an independent embodiment.

Although operations or steps are described in a specific order in the embodiments or the accompanying drawings of the present disclosure, it should not be understood in a way that these operations or steps are required to be performed in the shown specific order or in a serial order, or that all the shown operations or steps are required to be performed to obtain the expected results. In the embodiments of the present disclosure, without conflict, these operations or steps may be performed in any order, or these operations or steps may be performed in parallel, or some of these operations or steps may be performed, or the operations or steps in a plurality of embodiments or accompanying drawings may be arbitrarily combined, which is not limited in the embodiments of the present disclosure.

It is to be noted that the embodiments of the present disclosure are not exhaustive, but merely some illustrative embodiments, and are not taken as specific limitation to the protection scope of the present disclosure. Without conflict, each step in a certain embodiment may be implemented as an independent embodiment, and the steps may be arbitrarily combined. For example, a solution with some steps removed from a certain embodiment may also be implemented as an independent embodiment, and steps in a certain embodiment may be arbitrarily exchanged in order. In addition, implementations in a certain embodiment may be arbitrarily combined. In addition, the embodiments may be arbitrarily combined. For example, part or all steps of different embodiments may be arbitrarily combined, and a certain embodiment may be arbitrarily combined with an implementation of another embodiment.

An implementation environment of the embodiments of the present disclosure is first introduced below.

The technical solutions of the embodiments of the present disclosure may be applied to various communication systems. The communication system may include one or more of the 4th Generation (4G) communication system, the 5th Generation (5G) communication system, and other future wireless communication systems (such as 6G). The communication system may also include one or more of a Public Land Mobile Network (PLMN), a Device-to-Device (D2D) communication system, a Machine-to-Machine (M2M) communication system, an Internet of Things (IoT) communication system, a Vehicle-to-Everything (V2X) communication system, or other communication systems.

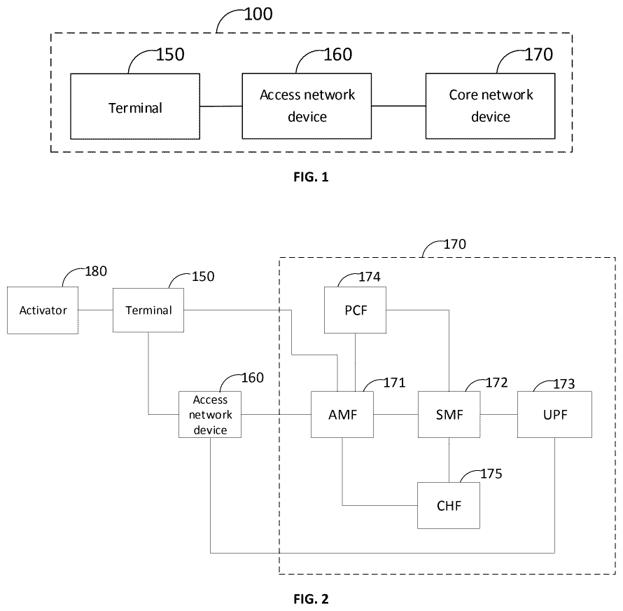

FIG. 1 is a schematic diagram of a communication system 100 according to an example. As shown in FIG. 1, the communication system 100 may include a terminal 150, an access network device 160, and a core network device 170. The communication system may be configured to support a 4G network access technology, such as a Long Term Evolution (LTE) access technology, or a 5G network access technology, such as a New Radio Access Technology (New RAT), or other future wireless communication technologies. The terminal may be connected to the access network device in a wireless manner, and the access network device may be connected to the core network device in a wireless or wired manner. The core network device and the access network device may be independent different physical devices, or functions of the core network device and logical functions of the access network device may be integrated on the same physical device, or some of the functions of the core network device and some of the functions of the access network device may be integrated on one physical device. It is to be noted that in this communication system, there may be one or more terminals, one or more access network devices, and one or more core network devices, and the numbers of the terminals, the access network devices, and the core network devices in the communication system shown in FIG. 1 are merely adaptive examples, which are not limited by the present disclosure. The terminals may be connected to each other in a wired or wireless manner, the access network devices may be connected to each other in a wired or wireless manner, and the core network devices may be connected to each other in a wired or wireless manner.

The core network device in FIG. 1 may be configured to perform one or more of functions, such as mobility management, session management, registration authentication, and charging, on the terminal. The core network device may include one or more entities, and the entity may be hardware, software divided from functions, or a structure combining the hardware and the software. It is to be noted that this entity may also be referred to as a function.

It is to be noted that the access network device and the core network device may be collectively referred to as a network device.

FIG. 2 is a schematic diagram of another communication system according to an example. As shown in FIG. 2, the communication system may include a terminal 150, an access network device 160, a core network device 170, and an activator 180. The core network device 170 in the communication system may include a plurality of functions, entities, or network elements. For example, the core network device 170 may include at least one of an AMF 171, an SMF 172, a User Plane Function (UPF) 173, a Policy Control Function (PCF) 174, or a CHF 175. It is to be noted that reference may be made to related descriptions in the related art (such as 3GPP protocols) for specific functions, connection relationships, and implementations of the AMF, SMF, UPF, PCF, and CHF, which is not repeated in the present disclosure.

The terminal 150 is powered by ambient power, and the ambient power may include solar energy, light, movement/vibration, heat, pressure, radio waves, etc. The terminal 150 provides an indication of an RAT type of the terminal for the access network device 160 in a Radio Resource Control (RRC) connection establishment process. In a case where the terminal 150 provides the RAT type of the terminal 150 for the access network device 160 in the RRC connection establishment process, the access network device 160 may provide the indication of the RAT type of the terminal 150 for the AMF 171 in an initial User Equipment (UE) message through an N2 interface. When the AMF 171 receives the indication of the indication of the RAT type from the access network device 160 in the initial UE message, the AMF 171 may store the indication of the RAT type in a context of the terminal 150, and consider the indication of the RAT type and send a signal to the SMF 172 in a Packet Data Unit (PDU) session establishment request message or PDU session modification process. The SMF 172 receives the indication of the RAT type from the AMF 171, stores the indication of the RAT type in the context of the terminal 150, and considers the indication of the RAT type and sends a signal to the PCF 174 in a Session Management (SM) policy association establishment or SM policy association modification process. The PCF 174 receives the indication of the RAT type from the SMF 172 in the SM policy association establishment or SM policy association modification process, and stores the indication of the RAT type in the context of the terminal 150. The PCF may unconditionally or conditionally authorize a Session-Access and Mobility Bit Rate (Session-AMBR), a default 5G Quality of Service (QoS) Identifier/Allocation and Retention Priority (5QI/ARP) combination of a PDU session, a PDU session type and/or an RAT type, and possible additional policy rules for PDU sessions of an Internet Protocol (IP) type, an Ethernet type, and an unstructured type. Call Detail Records (CDRs) generated by the AMF 171 and the SMF 172 include the indication of the RAT type of the terminal 150, and the indication of the RAT type of the terminal 150 may be sent to the CHF 175 for charging differentiation.

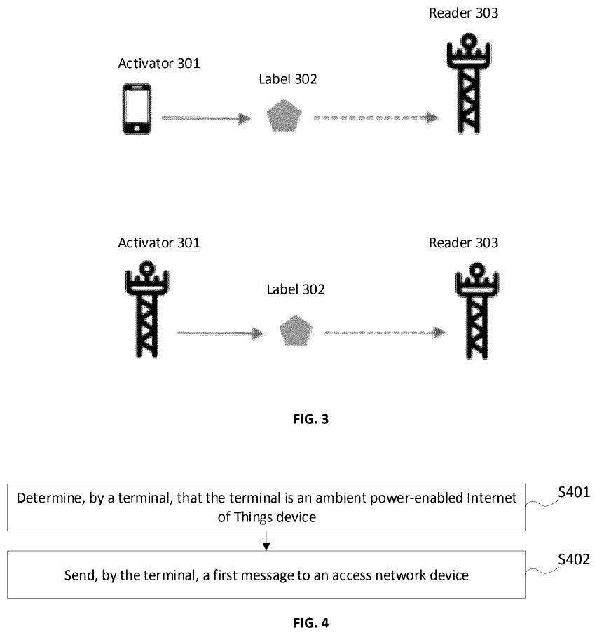

The terminal in FIG. 1 may be an ambient power-enabled Internet of Things device. The ambient power-enabled Internet of Things device may be an Internet of Things device powered by ambient power in an Ambient power-enabled Internet of Things (Ambient IoT), and the ambient power-enabled Internet of Things device does not need manual charging or battery replacement. FIG. 3 is a schematic diagram of an ambient power-enabled Internet of Things according to an example. As shown in FIG. 3, a label 302 (an ambient power-enabled Internet of Things device) may collect energy from radio waves, and the radio waves may come from a network entity or user equipment. The activator 301 may be UE or a network device. After receiving an activation signal from the activator 301, the label 302 may interact with a reader 303 (an access network device). Although the ambient power-enabled Internet of Things device has features of low complexity, a small size, low power consumption, and a long life cycle, the ambient power-enabled Internet of Things device still needs a sufficient communication service capacity to satisfy a corresponding requirement. In the embodiments of the present disclosure, the terminal may communicate with the access network device, or the terminal may communicate with the core network device through the access network device. A plurality of terminals may further communicate with one another. The terminal may be statically fixed or mobile, which is not limited by the present disclosure.

The access network device in FIG. 1 may be configured to support access of the terminal. For example, the access network device may be a Next Generation Radio Access Network (NG-RAN) device. The access network device may also be a base station in a future evolved PLMN, a Broadband Network Gateway (BNG), an aggregation switch, or a non-3GPP access device. In some examples, the access network device in the embodiments of the present disclosure may include various forms of base stations, such as a macro base station, a micro base station (also referred to as a small base station), a relay station, an access point, a 5G base station or a future base station, a satellite, a Transmitting and Receiving Point (TRP), a Transmitting Point (TP), a mobile switching center, Device-to-Device (D2D), Machine-to-Machine (M2M), Internet of Things (IoT), Vehicle-to-Everything (V2X), or other devices that perform a function of the base station in the communication system, etc., which is not specifically limited in the embodiments of the present disclosure. For convenience of description, in the embodiments of the present disclosure, devices that provide a wireless communication function for the terminal are collectively referred to as the access network device or the base station.

In some embodiments, the communication system may include the terminal 150 and the access network device 160.

In some other embodiments, the communication system may include the terminal 150, the access network device 160, the AMF 171, the SMF 172, and the CHF 175.

FIG. 4 is a flowchart of a policy control method according to an example. The method may be performed by the terminal in the communication system described above. As shown in FIG. 4, the method may include the following steps S401 and S402.

In step S401, the terminal determines that the terminal is an ambient power-enabled Internet of Things device.

The ambient power-enabled Internet of Things device may be an Internet of Things device powered by ambient power in an ambient power-enabled Internet of Things (an ambient Internet of Things). For example, the ambient power may be radio waves, solar energy, light, movement/vibration, heat, pressure, etc.

In step S402, the terminal sends a first message to an access network device.

The first message may be configured to perform policy control on the terminal.

In some embodiments, the policy control may be QoS control.

In some embodiments, the first message may be configured to indicate an RAT type of the terminal.

In an implementation, the RAT type of the terminal indicated by the first message may be an NR Ambient-IoT, and the NR Ambient-IoT may be a subtype of a New Radio (NR) RAT type.

In another implementation, the RAT type of the terminal indicated by the first message may be an Ambient-IoT, and the Ambient-IoT may be an RAT type juxtaposed with the NR RAT type and an LTE RAT type.

In some embodiments, the terminal may receive an activation signal sent by an activator in the ambient power-enabled Internet of Things, and send the first message to the access network device.

In some other embodiments, the terminal may send a connection establishment request to the access network device. The connection establishment request may include the first message.

For example, the connection establishment request may be an RRC connection request. The connection establishment request may include at least one of a registration type, a terminal identification parameter, or a security parameter, and the first message. The terminal identification parameter may include at least one of a Subscription Concealed Identifier (SUCI), a Globally Unique Temporary Identifier (GUTI), or a Permanent Equipment Identifier (PEI). The above GUTI may be a 5G-GUTI or a GUTI under other network standards, which is not limited by the embodiments of the present disclosure.

It is to be noted that step S401 may also not be performed before step S402.

By adopting the above method, the terminal may send the first message to the access network device, and the policy control may be performed on the terminal according to the first message. In this way, policy control on the ambient power-enabled Internet of Things device may be implemented.

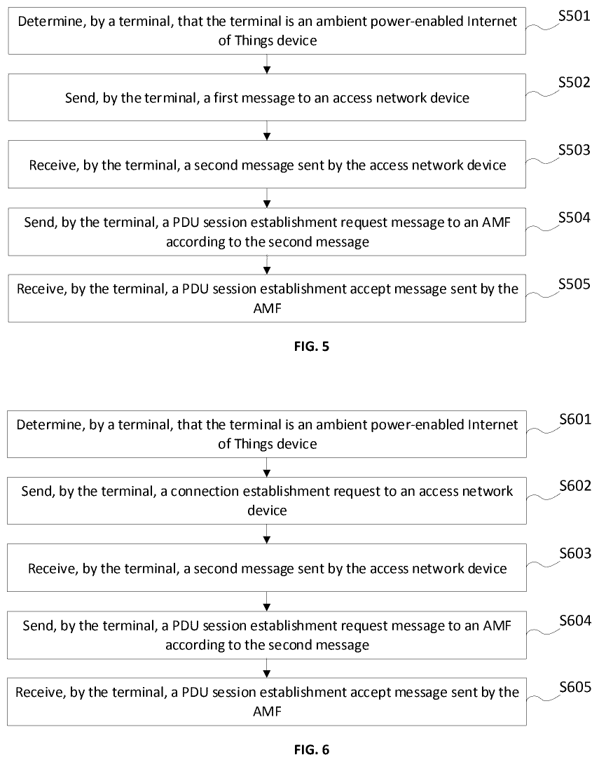

FIG. 5 is a flowchart of a policy control method according to an example. The method may be performed by the terminal in the communication system described above. As shown in FIG. 5, the method may include the following steps S501 to S505.

In step S501, the terminal determines that the terminal is an ambient power-enabled Internet of Things device.

The ambient power-enabled Internet of Things device may be an Internet of Things device powered by ambient power in an ambient power-enabled Internet of Things (an ambient Internet of Things). For example, the ambient power may be radio waves, solar energy, light, movement/vibration, heat, pressure, etc.

In step S502, the terminal sends a first message to an access network device.

The first message may be configured to perform policy control on the terminal.

In some embodiments, the policy control may be QoS control.

In step S503, the terminal receives a second message sent by the access network device.

The second message may indicate a network resource used by the terminal, and the second message may also be referred to as a registration accept message.

In some embodiments, after the terminal sends the first message to the access network device, the access network device sends a registration request to an AMF. The AMF may determine an RAT type of the terminal, and store the RAT type of the terminal in a context of the terminal. After storage by the AMF in the context is completed, the terminal may receive the second message sent, through the access network device, by the AMF.

In step S504, the terminal sends a PDU session establishment request message to the AMF according to the second message.

The PDU session establishment request message may include the first message, and the PDU session establishment request message is configured to request establishment of a PDU session.

In some embodiments, the terminal may send the PDU session establishment request message to the AMF according to the network resource that may be used by the terminal indicated by the second message, so as to request the AMF to establish the PDU session for the terminal according to the first message.

In step S505, the terminal receives a PDU session establishment accept message sent by the AMF.

The PDU session establishment accept message may be used by the terminal to transmit data, and the PDU session establishment accept message may include an IP address/prefix of the terminal.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here. Step S501 may also not be performed before step S502.

In this way, after sending the PDU session establishment request to the AMF, the terminal may receive the PDU session establishment accept message sent by the AMF, and thus establishment of the PDU session is completed. The terminal may send and receive data in a context of the established PDU session.

FIG. 6 is a flowchart of a policy control method according to an example. The method may be performed by the terminal in the communication system described above. As shown in FIG. 6, the method may include the following steps S601 to S605.

In step S601, the terminal determines that the terminal is an ambient power-enabled Internet of Things device.

The ambient power-enabled Internet of Things device may be an Internet of Things device powered by ambient power in an ambient power-enabled Internet of Things (an ambient Internet of Things). For example, the ambient power may be radio waves, solar energy, light, movement/vibration, heat, pressure, etc.

In step S602, the terminal sends a connection establishment request to an access network device.

The connection establishment request may include a first message, and the first message is configured to perform policy control on the terminal.

In some embodiments, the policy control may be QoS control.

For example, the connection establishment request may be an RRC connection request. The connection establishment request may include at least one of a registration type, a terminal identification parameter, or a security parameter, and the first message. The terminal identification parameter may include at least one of an SUCI, a GUTI, or a PEI. The above GUTI may be a 5G-GUTI or a GUTI under other network standards, which is not limited by the embodiments of the present disclosure.

In step S603, the terminal receives a second message sent by the access network device.

The second message may indicate a network resource used by the terminal, and the second message may also be referred to as a registration accept message.

In step S604, the terminal sends a PDU session establishment request message to an AMF according to the second message.

The PDU session establishment request message may include the first message.

In some embodiments, after receiving the second message, the terminal may send the PDU session establishment request message to the AMF according to the network resource that may be used by the terminal indicated by the second message, so as to request the AMF to establish a PDU session for the terminal according to the first message.

In step S605, the terminal receives a PDU session establishment accept message sent by the AMF.

The PDU session establishment accept message may be used by the terminal to transmit data, and the PDU session establishment accept message may include an IP address/prefix of the terminal.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here. The step S601 may also not be performed before step S602.

In this way, after sending the PDU session establishment request to the AMF, the terminal may receive the PDU session establishment accept message sent by the AMF, and thus may send and receive data in a context of the established PDU session.

FIG. 7 is a flowchart of a policy control method according to an example. The method may be performed by the access network device in the communication system described above. As shown in FIG. 7, the method may include the following steps S701 and S702.

In step S701, the access network device receives a first message sent by a terminal.

The first message may be configured to perform policy control on the terminal, and the terminal may be an ambient power-enabled Internet of Things device.

In some embodiments, the policy control may be QoS control.

In some embodiments, the first message may be configured to indicate an RAT type of the terminal.

In an implementation, the RAT type of the terminal indicated by the first message may be an NR Ambient-IoT, and the NR Ambient-IoT may be a subtype of an NR RAT type.

In another implementation, the RAT type of the terminal indicated by the first message may be an Ambient-IoT, and the Ambient-IoT may be an RAT type juxtaposed with the NR RAT type and an LTE RAT type.

In step S702, the access network device sends a registration request to an AMF.

The registration request may include at least one of the first message or a first RAT type, and the first RAT type may be an RAT type used by the terminal to access the access network device.

In some embodiments, the access network device may directly send the first message to the AMF after receiving the first message sent by the terminal.

In some other embodiments, the access network device may determine the first RAT type for the terminal to access the access network device, and send the registration request including the first RAT type to the AMF. For example, the access network device may determine a cell identifier of a service cell accessed by the terminal or a spectrum identifier used by the terminal, and take an RAT type corresponding to the cell identifier or the spectrum identifier as the first RAT type by a preset type association relationship. The type association relationship may include corresponding relationships between different cell identifiers and RAT types, or corresponding relationships between different spectrum identifiers and RAT types.

In some other embodiments, the access network device may send the registration request including the first message and the first RAT type to the AMF.

By adopting the above method, the access network device receives the first message sent by the terminal, and sends the registration request to the AMF, such that the policy control is performed on the terminal according to the first message. In this way, policy control on the ambient power-enabled Internet of Things device may be implemented.

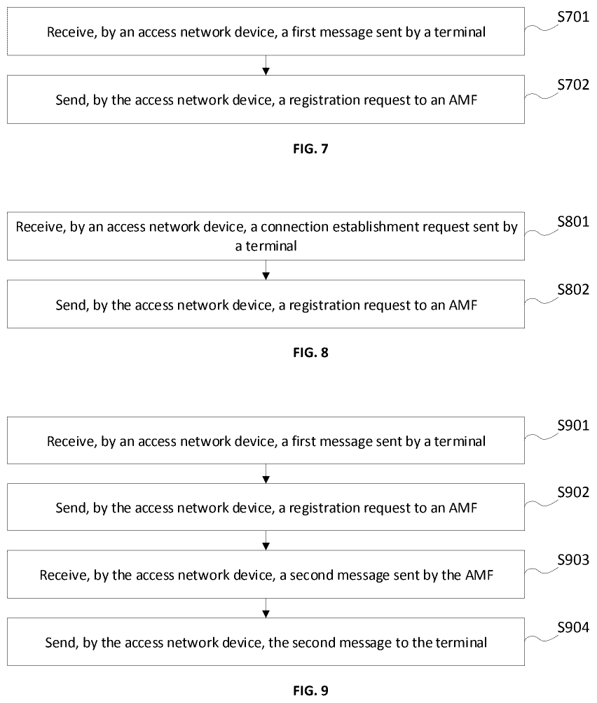

FIG. 8 is a flowchart of a policy control method according to an example. The method may be performed by the access network device in the communication system described above. As shown in FIG. 8, the method may include the following steps S801 and S802.

In step S801, the access network device receives a connection establishment request sent by a terminal.

The connection establishment request may include a first message. The first message is configured to perform policy control on the terminal, and the terminal may be an ambient power-enabled Internet of Things device.

In some embodiments, the policy control may be QoS control.

For example, the connection establishment request may be an RRC connection request. The connection establishment request may include at least one of a registration type, a terminal identification parameter, or a security parameter, and the first message. The terminal identification parameter may include at least one of an SUCI, a GUTI, or a PEI. The above GUTI may be a 5G-GUTI or a GUTI under other network standards, which is not limited by the embodiments of the present disclosure.

In step S802, the access network device sends a registration request to an AMF.

In some embodiments, the registration request may be referred to as a registration request message, and the registration request may also be referred to as an N2 establishment request.

The registration request may include at least one of the first message or a first RAT type, and the first RAT type may be an RAT type used by the terminal to access the access network device.

In some embodiments, after receiving the connection establishment request sent by the terminal, the access network device may send the connection establishment request to the AMF by transparent transmission.

In some other embodiments, the access network device may determine the first RAT type for the terminal to access the access network device, and send the registration request including the first RAT type to the AMF. For example, the access network device may determine a cell identifier of a service cell accessed by the terminal or a spectrum identifier used by the terminal, and take an RAT type corresponding to the cell identifier or the spectrum identifier as the first RAT type by a preset type association relationship. The type association relationship may include corresponding relationships between different cell identifiers and RAT types, or corresponding relationships between different spectrum identifiers and RAT types.

In some other embodiments, the access network device may send the registration request including the connection establishment request and the first RAT type to the AMF.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

By adopting the above method, the access network device receives the connection establishment request sent by the terminal, and sends the registration request to the AMF, such that the policy control is performed on the terminal according to the first message in the connection establishment request. In this way, policy control on the ambient power-enabled Internet of Things device may be implemented.

FIG. 9 is a flowchart of a policy control method according to an example. The method may be performed by the access network device in the communication system described above. As shown in FIG. 9, the method may include the following steps S901 to S904.

In step S901, the access network device receives a first message sent by a terminal.

The first message may be configured to perform policy control on the terminal, and the terminal may be an ambient power-enabled Internet of Things device.

In some embodiments, the policy control may be QoS control.

In step S902, the access network device sends a registration request to an AMF.

In some embodiments, the registration request may be referred to as a registration request message, and the registration request may further be referred to as an N2 establishment request.

In some embodiments, after receiving the first message sent by the terminal, the access network device may send the first message to the AMF by transparent transmission.

In some other embodiments, the access network device may determine a first RAT type for the terminal to access the access network device, and send the registration request including the first RAT type to the AMF. For example, the access network device may determine a cell identifier of a service cell accessed by the terminal or a spectrum identifier used by the terminal, and take an RAT type corresponding to the cell identifier or the spectrum identifier as the first RAT type by a preset type association relationship. The type association relationship may include corresponding relationships between different cell identifiers and RAT types, or corresponding relationships between different spectrum identifiers and RAT types.

In some other embodiments, the access network device may send the registration request including the first message and the first RAT type to the AMF.

In step S903, the access network device receives a second message sent by the AMF.

The second message may indicate a network resource used by the terminal, and the second message may also be referred to as a registration accept message.

In some embodiments, after the access network device sends the registration request to the AMF, the AMF may determine an RAT type of the terminal, and store the RAT type of the terminal in a context of the terminal. After storage by the AMF in the context is completed, the access network device may receive the second message sent by the AMF.

In step S904, the access network device sends the second message to the terminal.

In some embodiments, after the access network device sends the registration request to the AMF, the AMF may register the terminal according to the registration request. After registration by the AMF is completed, the access network device may receive the second message sent by the AMF, and send the second message to the terminal.

In this way, the registration of the terminal may be completed.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

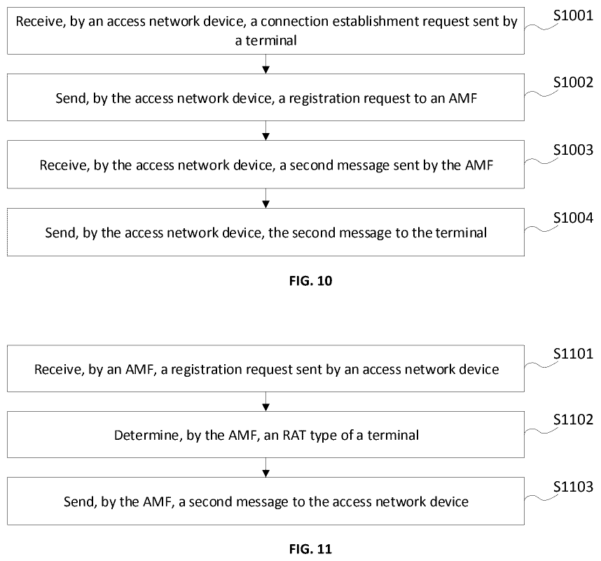

FIG. 10 is a flowchart of a policy control method according to an example. The method may be performed by the access network device in the communication system described above. As shown in FIG. 10, the method may include the following steps S1001 to S1004.

In step S1001, the access network device receives a connection establishment request sent by a terminal.

The connection establishment request may include a first message. The first message is configured to perform policy control on the terminal, and the terminal may be an ambient power-enabled Internet of Things device.

In some embodiments, the policy control may be QoS control.

For example, the connection establishment request may be an RRC connection request. The connection establishment request may include at least one of a registration type, a terminal identification parameter, or a security parameter, and the first message. The terminal identification parameter may include at least one of an SUCI, a GUTI, or a PEI. The above GUTI may be a 5G-GUTI or a GUTI under other network standards, which is not limited by the embodiments of the present disclosure.

In step S1002, the access network device sends a registration request to an AMF.

In some embodiments, after receiving the connection establishment request sent by the terminal, the access network device may directly send the connection establishment request to the AMF.

In some other embodiments, the access network device may determine a first RAT type for the terminal to access the access network device, and send the registration request including the first RAT type to the AMF. For example, the access network device may determine a cell identifier of a service cell accessed by the terminal or a spectrum identifier used by the terminal, determine a first to-be-determined RAT type corresponding to the cell identifier or the spectrum identifier by a preset first type association relationship, and take the first to-be-determined RAT type as the first RAT type. The first type association relationship may include corresponding relationships between different cell identifiers and RAT types, or corresponding relationships between different spectrum identifiers and RAT types.

In some other embodiments, the access network device may send the registration request including the connection establishment request and the first RAT type to the AMF.

In step S1003, the access network device receives a second message sent by the AMF.

The second message may indicate a network resource used by the terminal, and the second message may also be referred to as a registration accept message.

In step S1004, the access network device sends the second message to the terminal.

In some embodiments, after the access network device sends the registration request to the AMF, the AMF registers (for example, by authentication and authorization) the terminal according to the registration request. After registration succeeds, the access network device may receive the second message sent by the AMF, and send the second message to the terminal.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

In this way, the registration of the terminal may be completed.

FIG. 11 is a flowchart of a policy control method according to an example. The method may be performed by the AMF in the communication system described above. As shown in FIG. 11, the method may include the following steps S1101 to S1103.

In step S1101, the AMF receives a registration request sent by an access network device.

In some embodiments, the registration request may be referred to as a registration request message, and the registration request may further be referred to as an N2 establishment request.

The registration request may include at least one of a first message or a first RAT type. The first RAT type may be an RAT type used by a terminal to access the access network device, the first message may be configured to perform policy control on the terminal, and the terminal may be an ambient power-enabled Internet of Things device.

In some embodiments, the policy control may be QoS control.

In some embodiments, the first message may be configured to indicate an RAT type of the terminal.

In an implementation, the RAT type of the terminal indicated by the first message may be an NR Ambient-IoT, and the NR Ambient-IoT may be a subtype of an NR RAT type.

In another implementation, the RAT type of the terminal indicated by the first message may be an Ambient-IoT, and the Ambient-IoT may be an RAT type juxtaposed with the NR RAT type and an LTE RAT type.

In step S1102, the AMF determines the RAT type of the terminal.

The RAT type of the terminal may be an RAT type currently used by the terminal.

In some embodiments, the RAT type of the terminal is determined according to the first message.

For example, in a case where the registration request includes the first message, the RAT type of the terminal may be determined according to the first message.

In some other embodiments, it is determined that the RAT type of the terminal is the first RAT type.

For example, in a case where the registration request includes the first RAT type, the first RAT type may be taken as the RAT type of the terminal.

In some other embodiments, the RAT type of the terminal is determined according to the first message and the first RAT type.

For example, in a case where the registration request includes the first message and the first RAT type, the RAT type of the terminal may be determined according to the first message and the first RAT type. For example, the AMF may determine an RAT type supported by the terminal according to the RAT type included in the first message, and determine the RAT type of the terminal from the RAT type supported by the terminal according to the first RAT type.

In some other embodiments, the RAT type of the terminal is determined according to first information. The first information may include at least one of a global Radio Access Network (RAN) node identification or a tracking area indicated by the access network device.

In an implementation, in a case where the first information includes the global RAN node identification, the AMF may determine the RAT type of the terminal according to the global RAN node identification.

For example, a second to-be-determined RAT type corresponding to the global RAN node identification may be determined by a preset second type association relationship, and the second to-be-determined RAT type may be taken as the RAT type of the terminal. The second type association relationship may include corresponding relationships between different node identifications and RAT types.

In another implementation, in a case where the first information includes the tracking area indicated by the access network device, the AMF may determine the RAT type of the terminal according to the tracking area.

For example, a third to-be-determined RAT type corresponding to the tracking area indicated by the access network device may be determined by a preset third type association relationship, and the third to-be-determined RAT type may be taken as the RAT type of the terminal. The third type association relationship may include corresponding relationships between different tracking areas and RAT types.

In another implementation, in a case where the first information includes the global RAN node identification and the tracking area indicated by the access network device, the AMF may determine the RAT type of the terminal according to the global RAN node identification and the tracking area.

For example, the AMF may determine an RAN node in a current network by the global RAN node identification, and a fourth to-be-determined RAT type of the terminal may be determined according to a list of RAT types supported by the node. According to the tracking area indicated by the access network device, a location area where the terminal is currently located may be determined, and a PLMN identifier corresponding to the location area may be determined. A PLMN network used by the terminal may be determined according to the PLMN identifier. The RAT type of the terminal may be determined in combination with the fourth to-be-determined RAT type and the PLMN network used by the terminal.

In step S1103, the AMF sends a second message to the access network device.

The second message may indicate a network resource used by the terminal, and the second message may also be referred to as a registration accept message.

In some embodiments, after determining the RAT type of the terminal, the AMF may store the RAT type of the terminal in a context of the terminal, and send the second message to the access network device.

In this way, the AMF may complete registration of the terminal according to the registration request sent by the access network device.

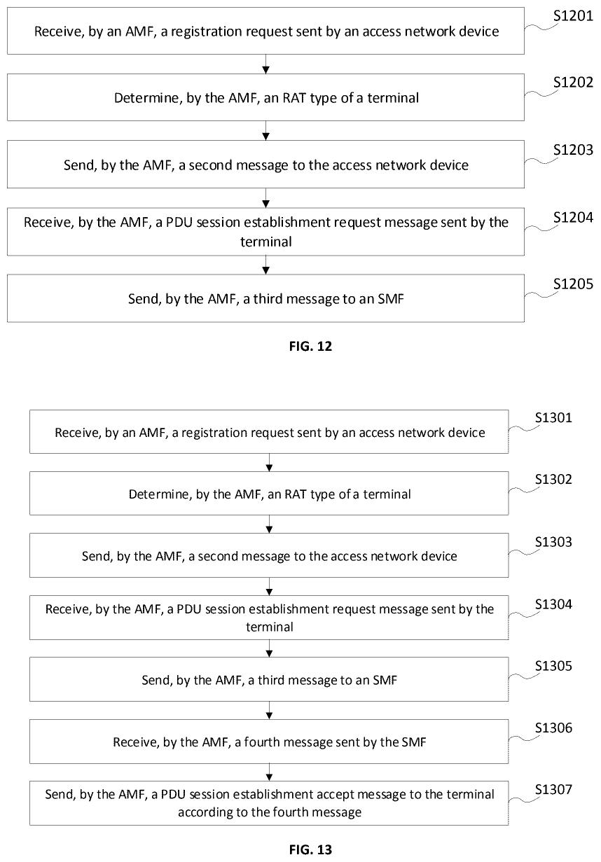

FIG. 12 is a flowchart of a policy control method according to an example. The method may be performed by the AMF in the communication system described above. As shown in FIG. 12, the method may include the following steps S1201 to S1205.

In step S1201, the AMF receives a registration request sent by an access network device.

It is to be noted that the registration request may also be referred to as a registration request message.

The registration request may include at least one of a first message or a first RAT type. The first RAT type may be an RAT type used by a terminal to access the access network device, the first message may be configured to perform policy control on the terminal, and the terminal may be an ambient power-enabled Internet of Things device.

In step S1202, the AMF determines the RAT type of the terminal.

The RAT type of the terminal may be an RAT type currently used by the terminal.

In some embodiments, the RAT type of the terminal is determined according to the first message.

For example, in a case where the registration request includes the first message, the RAT type of the terminal may be determined according to the first message.

In some other embodiments, it is determined that the RAT type of the terminal is the first RAT type.

For example, in a case where the registration request includes the first RAT type, the first RAT type may be taken as the RAT type of the terminal.

In some other embodiments, the RAT type of the terminal is determined according to the first message and the first RAT type.

For example, in a case where the registration request includes the first message and the first RAT type, the RAT type of the terminal may be determined according to the first message and the first RAT type. For example, the AMF may determine an RAT type supported by the terminal according to the RAT type included in the first message, and determine the RAT type of the terminal from the RAT type supported by the terminal according to the first RAT type.

In some other embodiments, the RAT type of the terminal is determined according to first information. The first information may include at least one of a global RAN node identification or a tracking area indicated by the access network device.

In an implementation, in a case where the first information includes the global RAN node identification, the AMF may determine the RAT type of the terminal according to the global RAN node identification.

For example, a second to-be-determined RAT type corresponding to the global RAN node identification may be determined by a preset second type association relationship, and the second to-be-determined RAT type may be taken as the RAT type of the terminal. The second type association relationship may include corresponding relationships between different node identifications and RAT types.

In another implementation, in a case where the first information includes the tracking area indicated by the access network device, the AMF may determine the RAT type of the terminal according to the tracking area.

For example, a third to-be-determined RAT type corresponding to the tracking area indicated by the access network device may be determined by a preset third type association relationship, and the third to-be-determined RAT type may be taken as the RAT type of the terminal. The third type association relationship may include corresponding relationships between different tracking areas and RAT types.

In another implementation, in a case where the first information includes the global RAN node identification and the tracking area indicated by the access network device, the AMF may determine the RAT type of the terminal according to the global RAN node identification and the tracking area.

For example, the AMF may determine an RAN node in a current network by the global RAN node identification, and a fourth to-be-determined RAT type of the terminal may be determined according to a list of RAT types supported by the node. According to the tracking area indicated by the access network device, a location area where the terminal is currently located may be determined, and a PLMN identifier corresponding to the location area may be determined. A PLMN network used by the terminal may be determined according to the PLMN identifier. The RAT type of the terminal may be determined in combination with the fourth to-be-determined RAT type and the PLMN network used by the terminal.

In step S1203, the AMF sends a second message to the access network device.

The second message indicates a network resource used by the terminal, and the second message may also be referred to as a registration accept message.

In some embodiments, after determining the RAT type of the terminal, the AMF may store the RAT type of the terminal in a context of the terminal, and send the second message to the access network device.

In step S1204, the AMF receives a PDU session establishment request message sent by the terminal.

The PDU session establishment request message may include the first message.

In step S1205, the AMF sends a third message to an SMF.

The third message may include the first message, and the third message may also be referred to as an Nsmf_PDUSession_CreateSMContext Request.

In some embodiments, after the AMF sends the second message to the terminal, it is determined that the terminal is registered successfully, and the terminal may send the PDU session establishment request message to the AMF. After receiving the PDU session establishment request message sent by the terminal, the AMF may send the third message to the SMF, so as to request the SMF to create a session management context for the terminal. A type of the session management context is the RAT type of the terminal indicated by the first message.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

In this way, the AMF may request the SMF to establish the session management context for the terminal according to the RAT type of the terminal indicated by the first message.

FIG. 13 is a flowchart of a policy control method according to an example. The method may be performed by the AMF in the communication system described above. As shown in FIG. 13, the method may include the following steps S1301 to S1307.

In step S1301, the AMF receives a registration request sent by an access network device.

The registration request may include at least one of a first message or a first RAT type. The first RAT type may be an RAT type used by a terminal to access the access network device, the first message may be configured to perform policy control on the terminal, and the terminal may be an ambient power-enabled Internet of Things device.

In some embodiments, the policy control may be QoS control.

In some embodiments, the registration request may be referred to as a registration request message, and the registration request may further be referred to as an N2 establishment request.

In step S1302, the AMF determines the RAT type of the terminal.

The RAT type of the terminal may be an RAT type currently used by the terminal.

In some embodiments, the RAT type of the terminal is determined according to the first message.

For example, in a case where the registration request includes the first message, the RAT type of the terminal may be determined according to the first message.

In some other embodiments, it is determined that the RAT type of the terminal is the first RAT type.

For example, in a case where the registration request includes the first RAT type, the first RAT type may be taken as the RAT type of the terminal.

In some other embodiments, the RAT type of the terminal is determined according to the first message and the first RAT type.

For example, in a case where the registration request includes the first message and the first RAT type, the RAT type of the terminal may be determined according to the first message and the first RAT type. For example, the AMF may determine an RAT type supported by the terminal according to the RAT type included in the first message, and determine the RAT type of the terminal from the RAT type supported by the terminal according to the first RAT type.

In some other embodiments, the RAT type of the terminal is determined according to first information. The first information may include at least one of a global Radio Access Network (RAN) node identification or a tracking area indicated by the access network device.

In an implementation, in a case where the first information includes the global RAN node identification, the AMF may determine the RAT type of the terminal according to the global RAN node identification.

For example, a second to-be-determined RAT type corresponding to the global RAN node identification may be determined by a preset second type association relationship, and the second to-be-determined RAT type may be taken as the RAT type of the terminal. The second type association relationship may include corresponding relationships between different node identifications and RAT types.

In another implementation, in a case where the first information includes the tracking area indicated by the access network device, the AMF may determine the RAT type of the terminal according to the tracking area.

For example, a third to-be-determined RAT type corresponding to the tracking area indicated by the access network device may be determined by a preset third type association relationship, and the third to-be-determined RAT type may be taken as the RAT type of the terminal. The third type association relationship may include corresponding relationships between different tracking areas and RAT types.

In another implementation, in a case where the first information includes the global RAN node identification and the tracking area indicated by the access network device, the AMF may determine the RAT type of the terminal according to the global RAN node identification and the tracking area.

For example, the AMF may determine an RAN node in a current network by the global RAN node identification, and a fourth to-be-determined RAT type of the terminal may be determined according to a list of RAT types supported by the node. According to the tracking area indicated by the access network device, a location area where the terminal is currently located may be determined, and a PLMN identifier corresponding to the location area may be determined. A PLMN network used by the terminal may be determined according to the PLMN identifier. The RAT type of the terminal may be determined in combination with the fourth to-be-determined RAT type and the PLMN network used by the terminal.

In step S1303, the AMF sends a second message to the access network device.

The second message indicates a network resource used by the terminal, and the second message may also be referred to as a registration accept message.

In some embodiments, after determining the RAT type of the terminal, the AMF may store the RAT type of the terminal in a context of the terminal, and send the second message to the access network device.

In step S1304, the AMF receives a PDU session establishment request message sent by the terminal.

The PDU session establishment request message may include the first message, and the PDU session establishment request message is configured to request establishment of a PDU session.

In step S1305, the AMF sends a third message to an SMF.

The third message may include the first message, and the third message may also be referred to as an Nsmf_PDUSession_CreateSMContext Request.

In some embodiments, after the AMF sends the second message to the terminal, it is determined that the terminal is registered successfully, and the terminal may send the PDU session establishment request message to the AMF. After receiving the PDU session establishment request message sent by the terminal, the AMF may send the third message to the SMF, so as to request the SMF to create a session management context for the terminal. A type of the session management context is the RAT type of the terminal indicated by the first message.

In step S1306, the AMF receives a fourth message sent by the SMF.

The fourth message may also be referred to an Namf_Communication_N1N2Message Transfer, and the fourth message may include an IP address/prefix allocated to the terminal.

In some embodiments, after the AMF sends the third message to the SMF, the SMF may create a PDU management context for the terminal according to the third message. After the SMF successfully creates the PDU management context, the fourth message sent by the SMF may be received.

In step S1307, the AMF sends a PDU session establishment accept message to the terminal according to the fourth message.

The PDU session establishment accept message may be used by the terminal to transmit data, and the PDU session establishment accept message may include the IP address/prefix of the terminal.

In some embodiments, after the AMF sends the third message to the SMF, the SMF creates a session context for the terminal. After completing the creation of the session context, the SMF sends the fourth message to the AMF. After receiving the fourth message, the AMF sends the PDU session establishment accept message to the terminal according to the fourth message.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

In this way, after receiving the fourth message sent by the SMF, the AMF may send the PDU session establishment accept message to the terminal, and the terminal may transmit the data according to the PDU session establishment accept message.

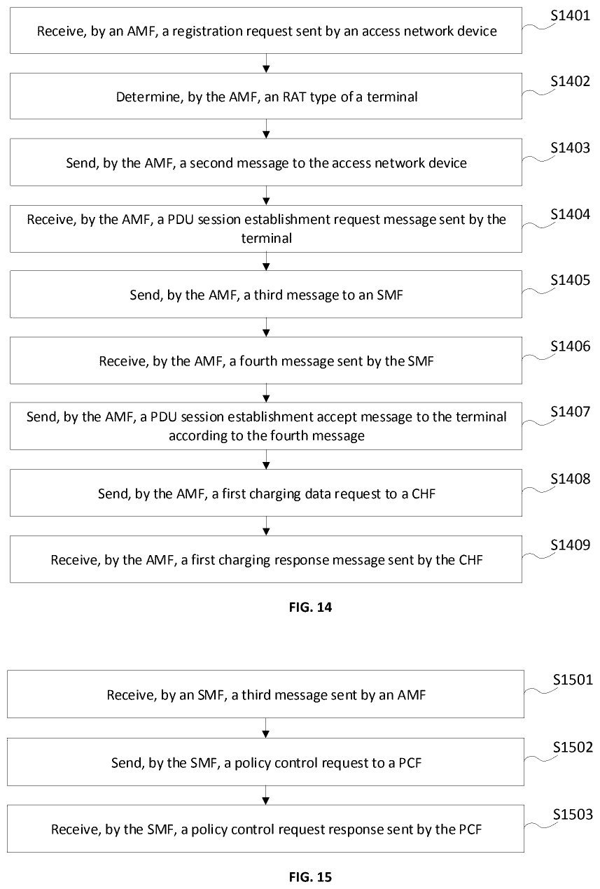

FIG. 14 is a flowchart of a policy control method according to an example. The method may be performed by the AMF in the communication system described above. As shown in FIG. 14, the method may include the following steps S1401 to S1409.

In step S1401, the AMF receives a registration request sent by an access network device.

It is to be noted that the registration request may also be referred to as a registration request message.

The registration request may include at least one of a first message or a first RAT type. The first RAT type may be an RAT type used by a terminal to access the access network device, the first message may be configured to perform policy control on the terminal, and the terminal may be an ambient power-enabled Internet of Things device.

In some embodiments, the policy control may be QoS control.

In step S1402, the AMF determines an RAT type of the terminal.

In step S1403, the AMF sends a second message to the access network device.

The second message indicates a network resource used by the terminal, and the second message may also be referred to as a registration accept message.

In some embodiments, after determining the RAT type of the terminal, the AMF may register the terminal according to the RAT type, and send the second message to the terminal after the registration succeeds.

In step S1404, the AMF receives a PDU session establishment request message sent by the terminal.

The PDU session establishment request message may include the first message.

In step S1405, the AMF sends a third message to an SMF.

The third message may include the first message, and the third message may also be referred to as an Nsmf_PDUSession_CreateSMContext request.

In some embodiments, after the AMF sends the second message to the terminal, it is determined that the terminal is registered successfully, and the terminal may send the PDU session establishment request message to the AMF. After receiving the PDU session establishment request message sent by the terminal, the AMF may send the third message to the SMF, so as to request the SMF to create a session management context for the terminal. A type of the session management context is the RAT type of the terminal indicated by the first message.

In some embodiments, after the SMF creates the session management context for the terminal, the AMF may receive an Nsmf_PDUSession_CreateSMContext Response sent by the SMF. The Nsmf_PDUSession_CreateSMContext Response may include information such as a PDU session identifier and a UPF allocated to a PDU session.

In step S1406, the AMF receives a fourth message sent by the SMF.

The fourth message may also be referred to as an Namf_Communication_N1N2Message Transfer.

In some embodiments, after the AMF sends the third message to the SMF, the SMF may create a PDU management context for the terminal according to the third message. After the SMF successfully creates the PDU management context, the fourth message sent by the SMF may be received.

In step S1407, the AMF sends a PDU session establishment accept message to the terminal according to the fourth message.

The PDU session establishment accept message may be used by the terminal to transmit data, and the PDU session establishment accept message may include an IP address/prefix of the terminal.

In some embodiments, after the AMF sends the third message to the SMF, the SMF creates a session context for the terminal. After completing the creation of the session context, the SMF sends the fourth message to the AMF. After receiving the fourth message, the AMF sends the PDU session establishment accept message to the terminal according to the fourth message.

In step S1408, the AMF sends a first charging data request to a CHF.

The first charging data request may include the first message, the first charging data request may also be referred to as a charging data request, and an RAT type of the first charging data request may be the RAT type of the terminal indicated by the first message.

In some embodiments, the first charging data request may be configured to request charging of a current PDU session service.

In some embodiments, after sending the PDU session establishment accept message to the terminal, the AMF may send the first charging data request to the CHF.

In step S1409, the AMF receives a first charging response message sent by the CHF.

The first charging response message may include first charging data of the terminal determined according to the first message.

In some embodiments, after the AMF sends the first charging data request to the CHF, the CHF may charge according to the RAT type of the first charging data request, and determine the first charging data. The AMF may receive the first charging response message, including the first charging data, sent by the CHF.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

In this way, the AMF may obtain the first charging data from the CHF by sending the first charging data request.

FIG. 15 is a flowchart of a policy control method according to an example. The method may be performed by the SMF in the communication system described above. As shown in FIG. 15, the method may include the following steps S1501 to S1503.

In step S1501, the SMF receives a third message sent by an AMF.

The third message may include a first message. The first message may be configured to perform policy control on the terminal, and the terminal may be an ambient power-enabled Internet of Things device. The third message may also be referred to as an Nsmf_PDUSession_CreateSMContext Request.

In some embodiments, the policy control may be QoS control.

In some embodiments, the first message may be configured to indicate an RAT type of the terminal.

In an implementation, the RAT type of the terminal indicated by the first message may be an NR Ambient-IoT, and the NR Ambient-IoT may be a subtype of an NR RAT type.

In another implementation, the RAT type of the terminal indicated by the first message may be an Ambient-IoT, and the ambient-IoT may be an RAT type juxtaposed with the NR RAT type and an LTE RAT type.

In some embodiments, after receiving a PDU session establishment request message sent by the terminal, the AMF may send the third message to the SMF. After receiving the third message sent by the AMF, the SMF may create a session management context for the terminal according to the third message. A type of the session management context is the RAT type of the terminal indicated by the first message.

In some embodiments, after creating the session management context for the terminal, the SMF may send an Nsmf_PDUSession_CreateSMContext Response to the AMF. The Nsmf_PDUSession_CreateSMContext Response may include information such as a PDU session identifier and a UPF allocated to a PDU session.

In step S1502, the SMF sends a policy control request to a PCF.

The policy control request may include the first message, and the policy control request may also be referred to as an Npcf_SMPolicyControl_Create request.

In some embodiments, the SMF may send the policy control request to the PCF according to the third message. The PCF may perform Policy and Charging Control (PCC) authorization according to the policy control request, and establish an SM policy association between the SMF and the PCF.

In step S1503, the SMF receives a policy control request response sent by the PCF.

The policy control request response may be used by the SMF to perform the policy control on the terminal, and the policy control request response may also be referred to as an Npcf_SMPolicyControl_Create response. The policy control request response may include an authorized Session-AMBR, a default 5QI/ARP combination of the PDU session, and a PDU session type and/or an RAT type.

In some embodiments, after completing the policy association with the SMF, the PCF may send the policy control request response to the SMF. After receiving the policy control request response sent by the PCF, the SMF may perform a PCF policy according to the policy control request response, so as to perform the policy control on the terminal.

By adopting the above method, the SMF may create the policy association between the SMF and the PCF according to the policy control request sent by the AMF, and receive the policy control request response sent by the PCF. In this way, the SMF may perform the policy control on the terminal according to the policy control request response.

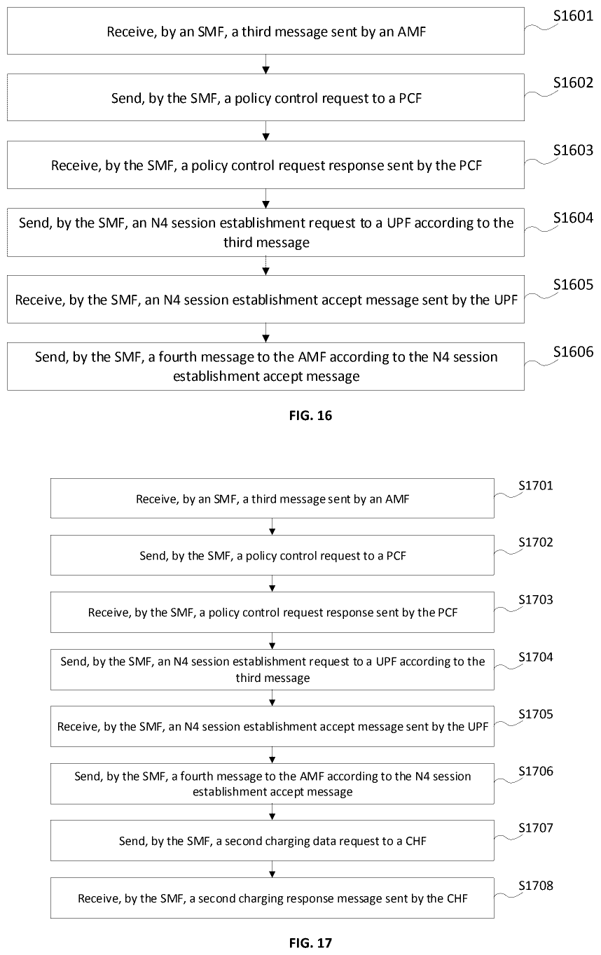

FIG. 16 is a flowchart of a policy control method according to an example. The method may be performed by the SMF in the communication system described above. As shown in FIG. 16, the method may include the following steps S1601 to S1606.

In step S1601, the SMF receives a third message sent by an AMF.

The third message may include a first message. The first message may be configured to perform policy control on the terminal, and the terminal may be an ambient power-enabled Internet of Things device. The third message may also be referred to as an Nsmf_PDUSession_CreateSMContext Request.

In some embodiments, the policy control may be QoS control.

In some embodiments, after receiving a PDU session establishment request message sent by the terminal, the AMF may send the third message to the SMF. After receiving the third message sent by the AMF, the SMF may create a session management context for the terminal according to the third message. A type of the session management context is an RAT type of the terminal indicated by the first message.

In some embodiments, after creating the session management context for the terminal, the SMF may send an Nsmf_PDUSession_CreateSMContext Response to the AMF. The Nsmf_PDUSession_CreateSMContext Response may include information such as a PDU session identifier and a UPF allocated to a PDU session.

In step S1602, the SMF sends a policy control request to a PCF.

The policy control request may include the first message, and the policy control request may also be referred to as an Npcf_SMPolicyControl_Create request.

In some embodiments, the SMF may send the policy control request to the PCF according to the third message. The PCF may perform PCC authorization according to the policy control request, and establish a policy association between the SMF and the PCF.

In step S1603, the SMF receives a policy control request response sent by the PCF.

The policy control request response may be used by the SMF to perform the policy control on the terminal, and the policy control request response may also be referred to as an Npcf_SMPolicyControl_Create response. The policy control request response may include an authorized Session-AMBR, a default 5QI/ARP combination of the PDU session, and a PDU session type and/or an RAT type.

In some embodiments, after completing the policy association with the SMF, the PCF may send the policy control request response to the SMF. After receiving the policy control request response sent by the PCF, the SMF may perform a PCF policy according to the policy control request response, so as to perform the policy control on the terminal.

In step S1604, the SMF sends an N4 session establishment request to the UPF according to the third message.

The N4 session establishment request may be used by the UPF to establish the PDU session for the terminal according to the first message.

In some embodiments, the SMF may send the N4 session establishment request to the UPF, and provide the UPF with detection, enforcement, and reporting rules of a packet that needs to be installed on the UPF for the PDU session.

In some embodiments, in a case where the SMF is configured to request the UPF to allocate an IP address, the N4 session establishment request may include allocation of the IP address/prefix, and information needed by the UPF to perform the allocation.

In step S1605, the SMF receives an N4 session establishment accept message sent by the UPF.

In some embodiments, after the SMF sends the N4 session establishment request to the UPF, the UPF may allocate the IP address to the terminal according to the N4 session establishment request. After the UPF completes the allocation of the IP address, the SMF may receive the N4 session establishment accept message, including the IP address/prefix of the terminal, sent by the UPF.

In step S1606, the SMF sends a fourth message to the AMF according to the N4 session establishment accept message.

The fourth message may be used by the AMF to send a PDU session establishment accept message to the terminal, and the PDU session establishment accept message is used by the terminal to transmit data. The fourth message may also be referred to t as an Namf_Communication_N1N2Message Transfer, and the fourth message may include the IP address/prefix of the terminal.

In some embodiments, after receiving the N4 session establishment accept message sent by the UPF, the SMF may send the fourth message to the AMF according to the N4 session establishment accept message.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

In this way, the SMF may send the N4 session establishment request to the UPF according to the third message sent by the AMF. After the UPF allocates the IP address to the terminal, the SMF may receive the N4 session establishment accept message sent by the UPF, and send the fourth message including the IP address/prefix of the terminal to the AMF according to the N4 session establishment accept message. The AMF may send the PDU session establishment accept message to the terminal according to the fourth message, and the terminal may transmit the data according to the PDU session establishment accept message.

FIG. 17 is a flowchart of a policy control method according to an example. The method may be performed by the SMF in the communication system described above. As shown in FIG. 17, the method may include the following steps S1701 to S1708.

In step S1701, the SMF receives a third message sent by an AMF.

The third message may include a first message. The first message may be configured to perform policy control on the terminal, and the terminal may be an ambient power-enabled Internet of Things device. The third message may also be referred to as an Nsmf_PDUSession_CreateSMContext Request.

In some embodiments, the policy control may be QoS control.

In some embodiments, after receiving a PDU session establishment request message sent by the terminal, the AMF may send the third message to the SMF. After receiving the third message sent by the AMF, the SMF may create a session management context for the terminal according to the third message. A type of the session management context is an RAT type of the terminal indicated by the first message.

In some embodiments, after creating the session management context for the terminal, the SMF may send an Nsmf_PDUSession_CreateSMContext Response to the AMF. The Nsmf_PDUSession_CreateSMContext Response may include information such as a PDU session identifier and a UPF allocated to a PDU session.

In step S1702, the SMF sends a policy control request to a PCF.

The policy control request may include the first message, and the policy control request may also be referred to as an Npcf_SMPolicyControl_Create request.

In some embodiments, the SMF may send the policy control request to the PCF according to the third message. The PCF may perform PCC authorization according to the policy control request, and establish a policy association between the SMF and the PCF.

In step S1703, the SMF receives a policy control request response sent by the PCF.

The policy control request response may be used by the SMF to perform the policy control on the terminal, and the policy control request response may also be referred to as an Npcf_SMPolicyControl_Create response. The policy control request response may include an authorized Session-AMBR, a default 5QI/ARP combination of the PDU session, and a PDU session type and/or an RAT type.

In some embodiments, after completing the policy association with the SMF, the PCF may send the policy control request response to the SMF. After receiving the policy control request response sent by the PCF, the SMF may perform a PCF policy according to the policy control request response, so as to perform the policy control on the terminal.

In step S1704, the SMF sends an N4 session establishment request to the UPF according to the third message.

The N4 session establishment request may be used by the UPF to establish the PDU session for the terminal according to the first message.

In some embodiments, the SMF may send the N4 session establishment request to the UPF, and provide the UPF with detection, enforcement, and reporting rules of a packet that needs to be installed on the UPF for the PDU session.

In some embodiments, in a case where the SMF is configured to request the UPF to allocate an IP address, the N4 session establishment request may include allocation of the IP address/prefix, and information needed by the UPF to perform the allocation. After the SMF sends the N4 session establishment request to the UPF, the UPF may allocate the IP address to the terminal according to the N4 session establishment request. After the UPF completes the allocation of the IP address, the SMF may receive an N4 session establishment accept message, including the IP address/prefix of the terminal, sent by the UPF.

In step S1705, the SMF receives the N4 session establishment accept message sent by the UPF.

In some embodiments, after the SMF sends the N4 session establishment request to the UPF, the UPF may allocate the IP address to the terminal according to the N4 session establishment request. After the UPF completes the allocation of the IP address, the SMF may receive the N4 session establishment accept message, including the IP address/prefix of the terminal, sent by the UPF.

In step S1706, the SMF sends a fourth message to the AMF according to the N4 session establishment accept message.

The fourth message may be used by the AMF to send a PDU session establishment accept message to the terminal, and the PDU session establishment accept message is used by the terminal to transmit data. The fourth message may also be referred to as an Namf_Communication_N1N2Message Transfer, and the fourth message may include the IP address/prefix of the terminal.

In some embodiments, after receiving the N4 session establishment accept message sent by the UPF, the SMF may send the fourth message to the AMF according to the N4 session establishment accept message.

In step S1707, the SMF sends a second charging data request to a CHF.

The second charging data request may include the first message. The second charging data request may also be referred to as a charging data request, and an RAT type of the second charging data request may be the RAT type of the terminal indicated by the first message.

In some embodiments, the second charging data request may be configured to request charging of a current PDU session service.

In an implementation, contents of the second charging data request may be different from those of the first charging data request.

In step S1708, the SMF receives a second charging response message sent by the CHF.

The second charging response message may include second charging data of the terminal determined according to the first message.

In some embodiments, after the SMF sends the second charging data request to the CHF, the CHF may determine the second charging data according to the RAT type of the second charging data request. The SMF may receive the second charging response message, including the second charging data, sent by the CHF.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

In this way, the SMF may obtain the second charging data from the CHF by sending the second charging data request.

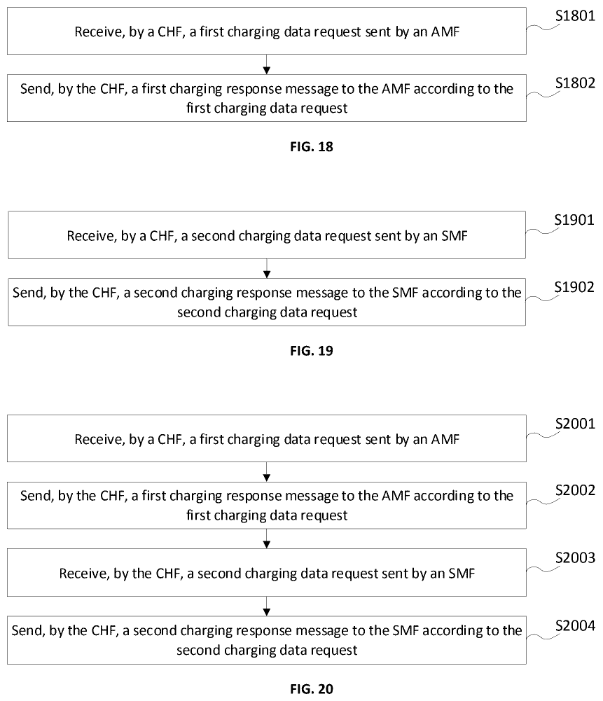

FIG. 18 is a flowchart of a charging method according to an example. The method may be performed by the CHF in the communication system described above. As shown in FIG. 18, the method may include the following steps S1801 and S1802.

In step S1801, the CHF receives a first charging data request sent by an AMF.

The first charging data request may include a first message. The first message may be configured to charge a terminal, and the terminal may be an ambient power-enabled Internet of Things device. The first charging data request may also be referred to as a charging data request, and an RAT type of the first charging data request may be an RAT type of the terminal indicated by the first message.

In some embodiments, the first message may be configured to indicate the RAT type of the terminal.

In an implementation, the RAT type of the terminal indicated by the first message may be an NR Ambient-IoT, and the NR Ambient-IT may be a subtype of an NR RAT type.

In another implementation, the RAT type of the terminal indicated by the first message may be an Ambient-IoT, and the Ambient-IoT may be an RAT type juxtaposed with the NR RAT type and an LTE RAT type.

In some embodiments, the first charging data request may be configured to request charging of a current PDU session service.

In some embodiments, after the AMF sends a PDU session establishment accept message to the terminal, the CHF may receive the first charging data request sent by the AMF.

In step S1802, the CHF sends a first charging response message to the AMF according to the first charging data request.

The first charging response message includes first charging data of the terminal.

In some embodiments, after receiving the first charging data request sent by the AMF, the CHF may create a CDR according to the RAT type of the first charging data request, record service information of a user for charging, determine the first charging data according to the CDR, and send the first charging response message including the first charging data to the AMF.

By adopting the above method, the CHF may perform charging control on the terminal according to the first charging data request, including the first message, sent by the AMF.

FIG. 19 is a flowchart of a charging method according to an example. The method may be performed by the CHF in the communication system described above. As shown in FIG. 19, the method may include the following steps S1901 and S1902.

In step S1901, the CHF receives a second charging data request sent by an SMF.

The second charging data request may include a first message. The first message may be configured to charge a terminal, and the terminal may be an ambient power-enabled Internet of Things device.

In some embodiments, the first message may be configured to indicate an RAT type of the terminal.

In an implementation, the RAT type of the terminal indicated by the first message may be an NR Ambient-IoT, and the NR Ambient-IoT may be a subtype of an NR RAT type.

In another implementation, the RAT type of the terminal indicated by the first message may be an Ambient-IoT, and the Ambient-IoT may be an RAT type juxtaposed with the NR RAT type and an LTE RAT type.

In some embodiments, the second charging data request may also be referred to as a charging data request, and an RAT type of the second charging data request may be the RAT type of the terminal indicated by the first message.

In some embodiments, the second charging data request may be configured to request charging of a current PDU session service.

In step S1902, the CHF sends a second charging response message to the SMF according to the second charging data request.

The second charging response message may include second charging data of the terminal.

In some embodiments, after receiving the second charging data request sent by the SMF, the CHF may create a CDR according to the RAT type of the second charging data request, record service information of a user for charging, determine the second charging data according to the CDR, and send the second charging response message including the second charging data to the SMF.

It is to be noted that the CDR created by the CHF for the SMF may be different from the CDR created by the CHF for the AMF, and a specific creation manner may be determined according to information in the charging data request sent by the AMF and the SMF.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

By adopting the above method, the CHF may perform charging control on the terminal according to the second charging data request, including the first message, sent by the SMF.

FIG. 20 is a flowchart of a charging method according to an example. The method may be performed by the CHF in the communication system described above. As shown in FIG. 20, the method may include the following steps S2001 to S2004.

In step S2001, the CHF receives a first charging data request sent by an AMF.

The first charging data request may include a first message. The first message may be configured to charge a terminal, and the terminal may be an ambient power-enabled Internet of Things device. The first charging data request may also be referred to as a charging data request, and an RAT type of the first charging data request may be an RAT type of the terminal indicated by the first message.

In some embodiments, the first message may be configured to indicate the RAT type of the terminal.

In an implementation, the RAT type of the terminal indicated by the first message may be an NR Ambient-IoT, and the NR Ambient-IoT may be a subtype of an NR RAT type.

In another implementation, the RAT type of the terminal indicated by the first message may be an Ambient-IoT, and the Ambient-IoT may be an RAT type juxtaposed with the NR RAT type and an LTE RAT type.

In some embodiments, the first charging data request may be configured to request charging of a current PDU session service.

In some embodiments, after the AMF sends a PDU session establishment accept message to the terminal, the CHF may receive the first charging data request sent by the AMF.

In step S2002, the CHF sends a first charging response message to the AMF according to the first charging data request.

The first charging response message includes first charging data of the terminal.

In some embodiments, after receiving the first charging data request sent by the AMF, the CHF may create a CDR according to the RAT type of the first charging data request, record call information and a call record of a user for charging, determine the first charging data according to the CDR, and send the first charging response message including the first charging data to the AMF.

In step S2003, the CHF receives a second charging data request sent by an SMF.

The second charging data request may include the first message. The first message may be configured to charge the terminal, and the terminal may be an ambient power-enabled Internet of Things device.

In some embodiments, the first message may be configured to indicate the RAT type of the terminal.

In an implementation, the RAT type of the terminal indicated by the first message may be the NR Ambient-IoT, and the NR Ambient-IoT may be a subtype of the NR RAT type.

In another implementation, the RAT type of the terminal indicated by the first message may be the Ambient-IoT, and the Ambient-IoT may be an RAT type juxtaposed with the NR RAT type and the LTE RAT type.

In some embodiments, the second charging data request may also be referred to as a charging data request, and an RAT type of the second charging data request may be the RAT type of the terminal indicated by the first message.

In some embodiments, the second charging data request may be configured to request charging of the current PDU session service.

In step S2004, the CHF sends a second charging response message to the SMF according to the second charging data request.

The second charging response message may include second charging data of the terminal.

In some embodiments, after receiving the second charging data request sent by the SMF, the CHF may create a CDR according to the RAT type of the second charging data request, record service information of the user for charging, determine the second charging data according to the CDR, and send the second charging response message including the second charging data to the SMF.

It is to be noted that the CDR created by the CHF for the SMF may be different from the CDR created by the CHF for the AMF, and a specific creation manner may be determined according to charging information in the charging data request sent by the AMF and the SMF. The first charging data request may include first charging information, and the second charging data request may include second charging information. The first charging information may be different from the second charging information.

It is to be noted that the performance order of steps S2001 to S2002 and steps S2003 to S2004 is described as an example. Steps S2003 to S2004 may be performed before steps S2001 to S2002 are performed, which is not limited in the embodiments of the present disclosure.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here.

In this way, the CHF may perform charging control on the terminal according to the first charging data request, including the first message, sent by the AMF, and perform the charging control on the terminal according to the second charging data request, including the first message, sent by the SMF.

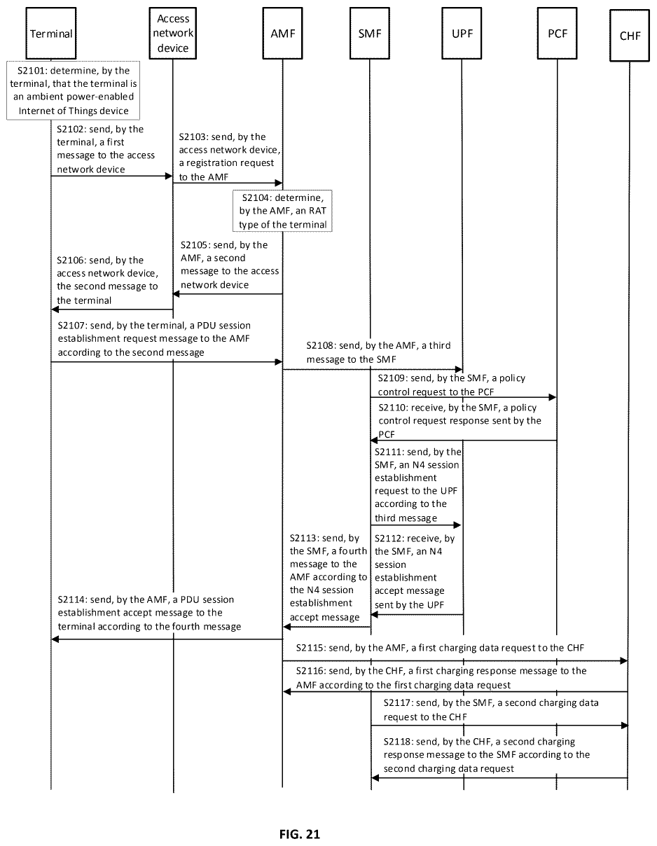

FIG. 21 is a flowchart of a policy control method and a charging method according to an example. As shown in FIG. 21, the method may include the following steps S2101 to S2118.

In step S2101, a terminal determines that the terminal is an ambient power-enabled Internet of Things device.

In step S2102, the terminal sends a first message to an access network device.

The first message may be configured to perform policy control on the terminal.

In some embodiments, the policy control may be QoS control.

In some embodiments, the first message may be configured to indicate an RAT type of the terminal.

In an implementation, the RAT type of the terminal indicated by the first message may be an NR Ambient-IoT, and the NR Ambient-IoT may be a subtype of an NR RAT type.

In another implementation, the RAT type of the terminal indicated by the first message may be an Ambient-IoT, and the Ambient-IoT may be an RAT type juxtaposed with the NR RAT type and an LTE RAT type.

In step S2103, the access network device sends a registration request to an AMF.

The registration request may include at least one of the first message or a first RAT type, and the first RAT type is an RAT type used by the terminal to access the access network device.

In step S2104, the AMF determines the RAT type of the terminal.

In some embodiments, the RAT type of the terminal may be determined according to the first message.

In some other embodiments, it may be determined that the RAT type of the terminal is the first RAT type.

In some other embodiments, the RAT type of the terminal may be determined according to the first message and the first RAT type.

In some other embodiments, the RAT type of the terminal may be determined according to first information. The first information includes at least one of a global RAN node identification or a tracking area indicated by the access network device.

In step S2105, the AMF sends a second message to the access network device.

The second message may indicate a network resource used by the terminal.

In step S2106, the access network device sends the second message to the terminal.

In step S2107, the terminal sends a PDU session establishment request message to the AMF according to the second message.

The PDU session establishment request message may include the first message.

In step S2108, the AMF sends a third message to an SMF.

The third message may include the first message.

In step S2109, the SMF sends a policy control request to a PCF.

The third message may include the first message. The first message may be configured to perform the policy control on the terminal, and the terminal may be an ambient power-enabled Internet of Things device. The policy control request may include the first message.

In step S2110, the SMF receives a policy control request response sent by the PCF.

The policy control request response is used by the SMF to perform the policy control on the terminal.

In step S2111, the SMF sends an N4 session establishment request to a UPF according to the third message.

The N4 session establishment request may be used by the UPF to establish a PDU session for the terminal according to the first message.

In step S2112, the SMF receives an N4 session establishment accept message sent by the UPF.

In step S2113, the SMF sends a fourth message to the AMF according to the N4 session establishment accept message.

The fourth message may be used by the AMF to send a PDU session establishment accept message to the terminal, and the PDU session establishment accept message may be used by the terminal to transmit data.

In step S2114, the AMF sends the PDU session establishment accept message to the terminal according to the fourth message.

The PDU session establishment accept message may be used by the terminal to transmit the data.

In step S2115, the AMF sends a first charging data request to a CHF.

The first charging data request may include the first message.

In step S2116, the CHF sends a first charging response message to the AMF according to the first charging data request.

The first charging response message may include first charging data of the terminal.

In step S2117, the SMF sends a second charging data request to the CHF.

The second charging data request may include the first message.

In step S2118, the CHF sends a second charging response message to the SMF according to the second charging data request.

The second charging response message may include second charging data of the terminal.

It is to be noted that the performance order of steps S2114 to S2115 and steps S2116 to S2117 is described as an example. Steps S2116 to S2117 may be performed before steps S2114 to S2115 are performed, which is not limited in the embodiments of the present disclosure.

It is to be noted that without conflict, this embodiment may be combined with the foregoing embodiments or implementations of the present disclosure, and various solutions thereof. Reference may also be made to the description in the foregoing embodiments of the present disclosure for the specific implementation of the above steps in this embodiment, which is not repeated here. It is to be noted that step S2101 may also not be performed before step S2102.

By adopting the above method, the communication system may implement the policy control and charging control on the terminal according to the first message.

In some embodiments of the present disclosure, the policy control method and the charging method may include the following steps 1 to 12.

In step 1, the terminal may send an RRC connection establishment request to an NG-RAN.

The RRC connection establishment request may include an NR Ambient-IoT or Ambient-IoT in addition to a registration type, a terminal identification parameter, or a security parameter. The terminal identification parameter may include an SUCI, a GUTI, or a PEI.

In step 2, after receiving the RRC connection establishment request, the NG-RAN may send an N2 establishment request to the AMF in at least one of manner (a) or manner (b).

In manner (a), the N2 establishment request includes the RRC connection establishment request from the NG-RAN to the AMF. The RRC connection establishment request includes the NR Ambient-IoT or Ambient-IoT, and the N2 establishment request may also include the NR Ambient-IoT or Ambient-IoT.

In manner (b), in a case where the NG-RAN determines that the terminal is accessing the NR using the NR Ambient-IoT or Ambient-IoT, for example, in a case where the NG-RAN determines that a specific cell or spectrum is using the NR Ambient-IoT or Ambient-IoT, the NR Ambient-IoT or Ambient-IoT may be indicated to the AMF in the N2 establishment request.

In step 3, after receiving the N2 establishment request sent by the access network device, the AMF may determine the RAT type of the terminal in any of manner (c), manner (d), or manner (e), and send a registration accept message to the NG-RAN.

In manner (c), the RAT type of the terminal is determined by a global RAN node identification (ID) associated with an N2 interface and a tracking area indicated by the NG-RAN. For the global RAN node ID and the tracking area indicated by the NG-RAN, a corresponding RAT type (the NR Ambient-IoT or Ambient-IoT) may be pre-configured in the AMF by an operator.

In manner (d), the NR Ambient-IoT or Ambient-IoT indicated by the NG-RAN is determined from the N2 establishment request.

In manner (e), in a case where NR Ambient-IoT or Ambient-IoT indication is provided in the N2 establishment request (registration request) provided by the terminal, the AMF stores the NR Ambient-IoT or Ambient-IoT indication in a context of the terminal, and determines that the RAT type of the terminal is the NR Ambient-IoT or Ambient-IoT.

In step 4, the terminal sends the PDU session establishment request to the AMF, so as to request establishment of a new PDU session.

In step 5, the AMF sends an Nsmf_PDUSession_CreateSMContext request to the SMF, an RAT type indicated in the Nsmf_PDUSession_CreateSMContext request is the NR Ambient-IoT or Ambient-IoT, and the SMF creates a session management context with an RAT type of the NR Ambient-IoT or Ambient-IoT for the terminal.

In step 6, the SMF sends a Nsmf_PDUSession_CreateSMContext response to the AMF, so as to complete an Nsmf_PDUSession_CreateSMContext operation.

In step 7, the SMF determines PCC authorization, and requests to establish an SM policy association with the PCF by invoking an Npcf_SMPolicyControl_Create operation. A request sent by the SMF to the PCF includes the NR Ambient-IoT or Ambient-IoT, and the PCF responds via an Npcf_SMPolicyControl_Create response. The PCF may unconditionally or conditionally authorize a Session-AMBR, a default 5QI/ARP combination of a PDU session, and a PDU session type and/or an RAT type for PDU sessions of an IP type, an Ethernet type, and an unstructured type. The SMF may perform a PCF policy.

In step 8, the SMF sends the N4 session establishment request to the UPF, and provides the UPF with detection, enforcement, and reporting rules of a packet that needs to be installed on the UPF for the PDU session. In a case where the SMF is configured to request the UPF to allocate an IP address, the SMF instructs the UPF to perform IP address/prefix allocation, and information needed by the UPF to perform the allocation is further included. In a case where a request is made by the SMF, the UPF sends an N4 session establishment response with the IP address/prefix of the terminal to the SMF.

In step 9, the SMF sends an Namf_Communication_N1N2Message Transfer, including an N1 SM container, to the AMF. The N1 SM container includes a PDU session establishment accept message. The AMF sends the PDU session establishment accept message to the terminal, and the PDU session establishment accept message includes the IP address/prefix of the terminal.

In step 10, the AMF sends the PDU session establishment accept message including the IP address/prefix of the terminal to the terminal. A user plane between the terminal and the UPF is established, and the terminal may send and receive data from a data network.

In step 11, the SMF sends a charging data request to the CHF. A type of the charging data request is the NR Ambient-IoT or Ambient-IoT, such that the terminal is successfully registered. The CHF creates a CDR for the charging data request, and the CHF confirms receipt of the charging data request by sending a charging data response to the SMF.

In step 12, the AMF sends a charging data request to the CHF. A type of the charging data request is the NR Ambient-IoT or Ambient-IoT, such that the terminal is successfully registered. The CHF creates a CDR for the charging data request, and the CHF confirms receipt of the charging data request by sending a charging data response to the SMF.

By adopting the above method, the policy control and charging control on the terminal may be implemented according to the first message.

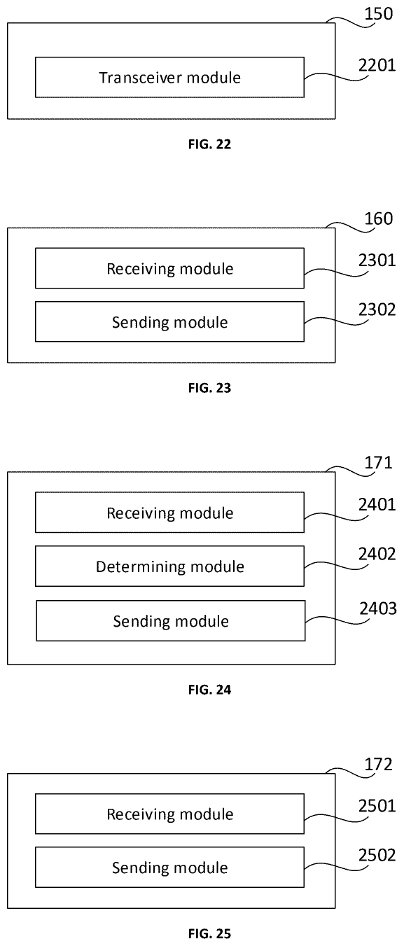

FIG. 22 is a block diagram of a terminal 150 according to an example. As shown in FIG. 22, the terminal may include a transceiver module 2201.

The transceiver module 2201 is configured to send a first message to an access network device. The first message is configured to perform policy control on the terminal.

In some embodiments, the first message is configured to indicate an RAT type of the terminal.

In some embodiments, the transceiver module 2201 is further configured to send a connection establishment request to the access network device. The connection establishment request includes the first message.

In some embodiments, the transceiver module 2201 is further configured to: receive a second message sent by the access network device, where the second message indicates a network resource used by the terminal; send a PDU session establishment request message to an AMF according to the second message, where the PDU session establishment request message includes the first message; and receive a PDU session establishment accept message sent by the AMF, where the PDU session establishment accept message is used by the terminal to transmit data.

FIG. 23 is a block diagram of an access network device 160 according to an example. As shown in FIG. 23, the access network device may include a receiving module 2301 and a sending module 2302.

The receiving module 2301 is configured to receive a first message sent by a terminal. The first message is configured to perform policy control on the terminal, and the terminal is an ambient power-enabled Internet of Things device.

The sending module 2302 is configured to send a registration request to an AMF. The registration request includes at least one of the first message or a first RAT type, and the first RAT type is an RAT type used by the terminal to access the access network device.

In some embodiments, the first message is configured to indicate an RAT type of the terminal.

In some embodiments, the receiving module 2301 is further configured to receive a connection establishment request sent by the terminal. The connection establishment request includes the first message.

In some embodiments, the receiving module 2301 is further configured to receive a second message sent by the AMF. The second message indicates a network resource used by the terminal. The sending module 2302 is further configured to send the second message to the terminal.

FIG. 24 is a block diagram of an AMF 171 according to an example. As shown in FIG. 24, the AMF may include a receiving module 2401, a determining module 2402, and a sending module 2403.

The receiving module 2401 is configured to receive a registration request sent by an access network device. The registration request includes at least one of a first message or a first RAT type, the first RAT type is an RAT type used by a terminal to access the access network device, the first message is configured to perform policy control on the terminal, and the terminal is an ambient power-enabled Internet of Things device.

The determining module 2402 is configured to determine an RAT type of the terminal.

The sending module 2403 is configured to send a second message to the access network device. The second message indicates a network resource used by the terminal.

In some embodiments, the first message is configured to indicate the RAT type of the terminal.

In some embodiments, the determining module 2402 is further configured to determine the RAT type of the terminal according to the first message; and/or, determine that the RAT type of the terminal is the first RAT type.

In some embodiments, the determining module 2402 is further configured to determine the RAT type of the terminal according to first information. The first information includes at least one of a global RAN node identification or a tracking area indicated by the access network device.

In some embodiments, the receiving module 2401 is further configured to receive a PDU session establishment request message sent by the terminal. The PDU session establishment request message includes the first message. The sending module 2403 is further configured to send a third message to an SMF. The third message includes the first message.

In some embodiments, the receiving module 2401 is further configured to receive a fourth message sent by the SMF. The sending module 2403 is further configured to send a PDU session establishment accept message to the terminal according to the fourth message. The PDU session establishment accept message is used by the terminal to transmit data.

In some embodiments, the sending module 2403 is further configured to send a first charging data request to a CHF. The first charging data request includes the first message. The receiving module 2401 is further configured to receive a first charging response message sent by the CHF. The first charging response message includes first charging data of the terminal determined according to the first message.

FIG. 25 is a block diagram of an SMF 172 according to an example. As shown in FIG. 25, the SMF may include a receiving module 2501 and a sending module 2502.

The receiving module 2501 is configured to receive a third message sent by an AMF. The third message includes a first message, the first message is configured to perform policy control on a terminal, and the terminal is an ambient power-enabled Internet of Things device.

The sending module 2502 is configured to send a policy control request to a PCF. The policy control request includes the first message.

The receiving module 2501 is further configured to receive a policy control request response sent by the PCF. The policy control request response is used by the SMF to perform the policy control on the terminal.

In some embodiments, the first message is configured to indicate an RAT type of the terminal.

In some embodiments, the sending module 2502 is further configured to send an N4 session establishment request to a UPF according to the third message. The N4 session establishment request is used by the UPF to establish a PDU session for the terminal according to the first message. The receiving module 2501 is further configured to receive an N4 session establishment accept message sent by the UPF. The sending module 2502 is further configured to send a fourth message to the AMF according to the N4 session establishment accept message. The fourth message is used by the AMF to send a PDU session establishment accept message to the terminal, and the PDU session establishment accept message is used by the terminal to transmit data.

In some embodiments, the sending module 2502 is further configured to send a second charging data request to a CHF. The second charging data request includes the first message. The receiving module 2501 is further configured to receive a second charging response message sent by the CHF. The second charging response message includes second charging data of the terminal determined according to the first message.

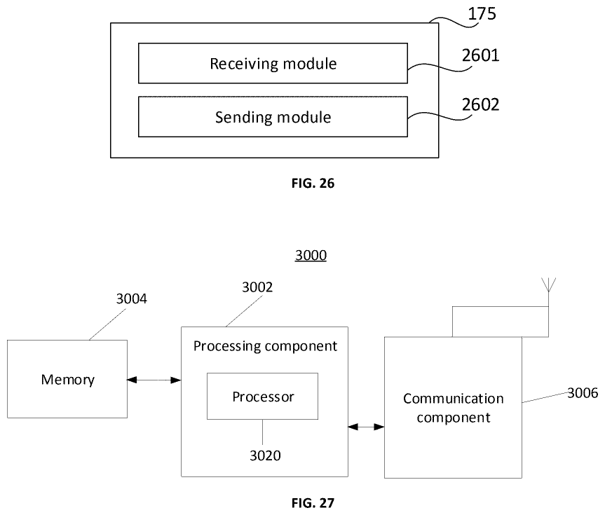

FIG. 26 is a block diagram of a CHF 175 according to an example. As shown in FIG. 26, the CHF may include a receiving module 2601 and a sending module 2602.

The receiving module 2601 is configured to receive a first charging data request sent by an AMF. The first charging data request includes a first message, the first message is configured to charge a terminal, and the terminal is an ambient power-enabled Internet of Things device.

The sending module 2602 is configured to send a first charging response message to the AMF according to the first charging data request. The first charging response message includes first charging data of the terminal.

In some embodiments, the receiving module 2601 is further configured to receive a second charging data request sent by an SMF. The second charging data request includes the first message. The sending module 2602 is further configured to send a second charging response message to the SMF according to the second charging data request. The second charging response message includes second charging data of the terminal.

In some embodiments, the first message is configured to indicate an RAT type of the terminal.

With respect to the devices in the embodiments described above, specific manners in which the modules perform operations have been described in detail in the embodiments related to the method, and are not described in detail here.

FIG. 27 is a block diagram of a communication device according to an example. The communication device 3000 may be the terminal, the access network device, or the core network device in the communication system shown in FIG. 1. The communication device 3000 may also be the terminal, the access network device, the AMF, the SMF, the UPF, the PCF, or the CHF in the communication system shown in FIG. 2.

With reference to FIG. 27, the device 3000 may include one or more of the following components: a processing component 3002, a memory 3004, and a communication component 3006.

The processing component 3002 may be configured to control an overall operation of the device 3000, such as an operation associated with display, a telephone call, data communication, a camera operation, and a recording operation. The processing component 3002 may include one or more processors 3020 for executing instructions, so as to complete all or part of steps of the policy control method and the charging method described above. In addition, the processing component 3002 may include one or more modules for interaction between the processing component 3002 and other components. For example, the processing component 3002 may include a multimedia module for interaction between the multimedia component and the processing component 3002.

The memory 3004 is configured to store various data to support the operation of the device 3000. Instances of such data include instructions for any application or method operated on the device 3000, contact data, phonebook data, messages, pictures, videos, etc. The memory 3004 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The communication component 3006 is configured to facilitate wired or wireless communication between the device 3000 and other devices. The device 3000 may access a wireless network based on a communication standard, such as Wi-Fi, 2G, 3G, 4G, 5G, 6G, narrow band Internet of Things (NB-IOT), enhanced machine-type communication (eMTC), or their combinations. In an example, the communication component 3006 receives a broadcast signal or broadcast related information from an external broadcast management system via a broadcast channel. In an example, the communication component 3006 further includes a near field communication (NFC) module to promote short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the device 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the policy control method and the charging method.

The device 3000 may be a separate electronic device or a part of the separate electronic device. For example, in an embodiment, the electronic device may be an Integrated Circuit (IC) or a chip. The integrated circuit may be one IC or a set of a plurality of ICs, and the chip may include, but is not limited to, the following categories: a Graphics Processing Unit (GPU), a Central Processing Unit (CPU), a Field Programmable Gate Array (FPGA), a Digital Signal Processor (DSP), an Application Specific Integrated Circuit (ASIC), a System on Chip (SOC), etc. The integrated circuit or chip may be configured to execute executable instructions (or codes), so as to implement the policy control method and the charging method. The executable instructions may be stored in the integrated circuit or chip, or may be obtained from other apparatuses or devices. For example, the integrated circuit or chip includes a processor, a memory, and an interface for communicating with other devices. The executable instructions may be stored in the processor. The executable instructions, when executed by the processor, implement the policy control method and the charging method. Alternatively, the integrated circuit or chip may receive the executable instructions through the interface and transmit the executable instructions to the processor for being executed, so as to implement the policy control method and the charging method.

In an example, the present disclosure further provides a computer-readable storage medium having stored thereon computer program instructions. The program instructions, when executed by a processor, implement the steps of the policy control method and the charging method provided by the present disclosure. For example, the computer-readable storage medium may be a non-transitory computer-readable storage medium including instructions, such as the memory 3004 including the instructions. The instructions may be executed by the processor 3020 of the device 3000, so as to complete the policy control method and the charging method. For example, the non-transitory computer-readable storage medium may be an ROM, a random access memory (RAM), a compact disc read-only memory (CD-ROM), a magnetic tape, a floppy disc, an optical data storage device, etc.

In another example, a computer program product is further provided. The computer program product includes a computer program executable by a programmable device, and the computer program has code portions configured to, when executed by the programmable device, perform the policy control method and the charging method.

A person of ordinary skill in the art may readily conceive of other implementations of the present disclosure after considering the specification and practicing the present disclosure. The present disclosure is intended to cover any modifications, uses, or adaptive changes of the present disclosure. These modifications, uses, or adaptive changes follow general principles of the present disclosure and include common general knowledge or conventional technical means in the art not disclosed in the present disclosure. The specification and embodiments are merely considered as examples, and the true scope and spirit of the present disclosure are indicated by the following claims.

It is to be understood that the present disclosure is not limited to precise structures described above and shown in the accompanying drawings, and various modifications and changes may be made without departing from the scope of the present disclosure. The scope of the present disclosure is merely limited by the appended claims.

1. A policy control method, performed by a terminal, wherein the terminal is an ambient power-enabled Internet of Things device, and the policy control method comprises:
sending a first message to an access network device, wherein the first message is configured to perform policy control on the terminal.

2. The policy control method according to claim 1, wherein the first message is configured to indicate a radio access technology (RAT) type of the terminal;
wherein sending the first message to the access network device comprises:
sending a connection establishment request to the access network device, wherein the connection establishment request comprises the first message.

3. (canceled)

4. The policy control method according to claim 1, further comprising:
receiving a second message sent by the access network device, wherein the second message indicates a network resource used by the terminal;
sending a packet data unit (PDU) session establishment request message to an access and mobility management function (AMF) according to the second message, wherein the PDU session establishment request message comprises the first message; and
receiving a PDU session establishment accept message sent by the AMF, wherein the PDU session establishment accept message is used by the terminal to transmit data.

5. A policy control method, performed by an access network device, comprising:
receiving a first message sent by a terminal, wherein the first message is configured to perform policy control on the terminal, and the terminal is an ambient power-enabled Internet of Things device; and
sending a registration request to an access and mobility management function (AMF), wherein the registration request comprises at least one of the first message or a first radio access technology (RAT) type, and the first RAT type is an RAT type used by the terminal to access the access network device.

6. The policy control method according to claim 5, wherein the first message is configured to indicate an RAT type of the terminal;
wherein receiving the first message sent by the terminal comprises:
receiving a connection establishment request sent by the terminal, wherein the connection establishment request comprises the first message.

7. (canceled)

8. The policy control method according to claim 5, further comprising:
receiving a second message sent by the AMF, wherein the second message indicates a network resource used by the terminal; and
sending the second message to the terminal.

9. A method, performed by a communication system, wherein the communication system comprises an access and mobility management function (AMF), and the method comprises:
receiving, by the AMF, a registration request sent by an access network device, wherein the registration request comprises at least one of a first message or a first radio access technology (RAT) type, the first RAT type is an RAT type used by a terminal to access the access network device, the first message is configured to perform policy control on the terminal, and the terminal is an ambient power-enabled Internet of Things device;
determining, by the AMF, an RAT type of the terminal; and
sending, by the AMF, a second message to the access network device, wherein the second message indicates a network resource used by the terminal.

10. The method according to claim 9, wherein the first message is configured to indicate the RAT type of the terminal;
wherein determining, by the AMF, the RAT type of the terminal comprises at least one of the following:
determining, by the AMF, the RAT type of the terminal according to the first message; or
determining, by the AMF, that the RAT type of the terminal is the first RAT type.

11. (canceled)

12. The method according to claim 9, wherein determining, by the AMF, the RAT type of the terminal comprises:
determining, by the AMF, the RAT type of the terminal according to first information, wherein the first information comprises at least one of a global radio access network (RAN) node identification or a tracking area indicated by the access network device.

13. The method according to claim 9, further comprising:
receiving, by the AME, a packet data unit (PDU) session establishment request message sent by the terminal, wherein the PDU session establishment request message comprises the first message; and
sending, by the AMF, a third message to a session management function (SMF), wherein the third message comprises the first message.

14. The method according to claim 13, further comprising:
receiving, by the AME, a fourth message sent by the SMF; and
sending, by the AMF, a PDU session establishment accept message to the terminal according to the fourth message, wherein the PDU session establishment accept message is used by the terminal to transmit data.

15. The method according to claim 14, further comprising:
sending, by the AMF, a first charging data request to a charging function (CHF), wherein the first charging data request comprises the first message; and
receiving, by the AMF, a first charging response message sent by the CHF, wherein the first charging response message comprises first charging data of the terminal determined according to the first charging data request.

16. The method according to claim 9, wherein the communication system further comprises a session management function (SMF), and the method further comprises:
receiving, by the SMF, a third message sent by the AMF;
sending, by the SMF, a policy control request to a policy control function (PCF), wherein the policy control request comprises the first message; and
receiving, by the SMF, a policy control request response sent by the PCF, wherein the policy control request response is used by the SMF to perform the policy control on the terminal.

17. (canceled)

18. The method according to claim 16, further comprising:
sending, by the SMF, an N4 session establishment request to a user plane function (UPF) according to the third message, wherein the N4 session establishment request is used by the UPF to establish a packet data unit (PDU) session for the terminal according to the first message;
receiving, by the SMF, an N4 session establishment accept message sent by the UPF; and
sending, by the SMF, a fourth message to the AMF according to the N4 session establishment accept message, wherein the fourth message is used by the AMF to send a PDU session establishment accept message to the terminal, and the PDU session establishment accept message is used by the terminal to transmit data.

19. The method according to claim 18, further comprising:
sending, by the SMF, a second charging data request to a charging function (CHF), wherein the second charging data request comprises the first message; and
receiving, by the SMF, a second charging response message sent by the CHF, wherein the second charging response message comprises second charging data of the terminal determined according to the second charging data request.

20. The method according to claim 9, wherein the communication system further comprises a charging function (CHF), and the method further comprises:
receiving, by the CHF, a first charging data request sent by the AMF, wherein the first charging data request comprises the first message, and the first message is configured to charge the terminal; and
sending, by the CHF, a first charging response message to the AMF according to the first charging data request.

21. The method according to claim 20, further comprising:
receiving, by the CHF, a second charging data request sent by a session management function (SMF); and
sending, by the CHF, a second charging response message to the SMF according to the second charging data request.

22-24. (canceled)

25. A terminal, comprising a processor and a memory, wherein
the memory is configured to store a computer program; and
the processor is configured to execute the computer program to perform the policy control method according to claim 1.

26. An access network device, comprising a processor and a memory, wherein
the memory is configured to store a computer program; and
the processor is configured to execute the computer program to perform the policy control method according to claim 5.

27. A communication system, comprising a processor and a memory, wherein
the memory is configured to store a computer program; and
the processor is configured to execute the computer program to perform the method according to claim 9.

28-31. (canceled)
